(19) United States
(12) Patent Application Publication
(10) Pub. No.: US 2024/0429417 A1
(43) Pub. Date: Dec. 26, 2024

(54) ELECTRODE MATERIAL, METHOD FOR PRODUCING SAME, AND ELECTRODE USING SAME, MEMBRANE ELECTRODE ASSEMBLY, AND POLYMER ELECTROLYTE FUEL CELL

(71) Applicant: KYUSHU UNIVERSITY, NATIONAL UNIVERSITY CORPORATION, Fukuoka (JP)

(72) Inventors: Zhiyun NODA, Fukuoka (JP); Ryosuke NISHIIZUMI, Fukuoka (JP); Yusuke INOUE, Fukuoka (JP); Junko MATSUDA, Fukuoka (JP); Masamichi NISHIHARA, Fukuoka (JP); Akari HAYASHI, Fukuoka (JP); Kazunari SASAKI, Fukuoka (JP)

(21) Appl. No.: 18/764,924

(22) Filed: Jul. 5, 2024

Related U.S. Application Data
(63) Continuation of application No. PCT/JP2023/000286, filed on Jan. 10, 2023.

(30) Foreign Application Priority Data
Jan. 10, 2022 (JP) 2022-001995
Mar. 14, 2022 (JP) 2022-039083

(51) Int. Cl. H01M 8/1048; H01M 8/1004; H01M 8/1067; H01M 8/12; H01M 8/1246

(52) U.S. Cl. CPC H01M 8/1048; H01M 8/1004; H01M 8/1067; H01M 8/1246; H01M 2008/1293

(57) ABSTRACT

The present invention provides either electrode material (A) or electrode material (B). An electrode material being an electrode material (A) including a porous composite support including, a carbon support formed of mesoporous carbon having an internal surface inside pores and an external surface outside the pores, and an electron conducting oxide adhered to at least the internal surface inside the pores of the mesoporous carbon, and electrode catalyst particles supported on the porous composite support, in which some or all of the electrode catalyst particles are supported via the electron conducting oxide in the pores of the mesoporous carbon; or an electrode material (B) including a carbon support formed of mesoporous carbon having an internal surface inside pores and an external surface outside the pores, and an electrode catalyst composite body adhered to at least the internal surface inside the pores of the mesoporous carbon, in which the electrode catalyst composite body includes electrode catalyst particles and an electron conducting oxide, and the electron conducting oxide fills gaps between the electrode catalyst particles.

### REFERENCE TO RELATED APPLICATION

The present application is a continuation of the international application (PCT/JP2023/000286, filing date: Jan. 10, 2023), and claims the benefit and priority of Japanese Patent Application No. 2022-1995, filed on Jan. 10, 2022, and Japanese Patent Application No. 2022-39083, filed on Mar. 14, 2022. The entire disclosure of these applications is incorporated herein by reference.

### TECHNICAL FIELD

The present invention relates to an electrode material suitable for an electrode of a polymer electrolyte fuel cell, and also relates to an electrode, a membrane electrode assembly, and a polymer electrolyte fuel cell using the electrode material.

### BACKGROUND ART

A fuel cell vehicle (FCV) using a polymer electrolyte fuel cell (PEFC) as a power source has already been put on the market, and PEFCs are expected to have a variety of applications, such as trucks, buses, ships, and the like, and be widely used. The PEFC generally has a structure in which a membrane electrode assembly (MEA) including a solid polymer electrolyte membrane and a pair of electrodes disposed on both surfaces of the solid polymer electrolyte membrane is sandwiched by separators in which gas flow paths are formed. A fuel cell electrode (particularly an electrode for PEFC) is generally composed of an electrode catalyst layer including an electrode material having an electrode catalytic activity and a polymer electrolyte, and a gas diffusion layer which is gas permeable and electron conductive.

Currently, an electrode material in which electrode catalyst fine particles (typically, Pt or Pt alloy fine particles) are dispersively supported on a carbon support is widely used as an electrode material for PEFCs. In addition, in recent years, an electrode material in which mesoporous carbon is used as a skeleton of a catalyst support and Pt fine particles are supported in pores (mesopores) of the mesoporous carbon (for example, Patent Documents 1 and 2) has attracted attention. Mesoporous carbon has excellent electronic conductivity, high gas diffusion ability, and a high surface area, and thus can be used as a support of an electrode catalyst of a polymer electrolyte fuel cell to produce an electrode exhibiting excellent power generation performance.

However, the electrolyte membrane of the PEFC is acidic (pH=0 to 3), and thus the electrode material of the PEFC is used under an acidic atmosphere. In addition, it is known that, while the cell voltage during normal operation is from 0.4 to 1.0 V, the cell voltage rises to 1.5 V at the time of start or stop of operation. When the cathode and the anode is under such a PEFC operating condition, the carbon-based material of the cathode serving as the support is decomposed to carbon dioxide (CO₂). Therefore, at the cathode, a reaction occurs in which the carbon support is electrochemically oxidized and decomposed into CO₂, and as a result, the carbon support is corroded (carbon corrosion). This causes aggregation, detachment, and the like of Pt particles which are a catalytically active component, resulting in performance degradation of the fuel cell. The risk of decomposition is not limited to the cathode. In a part of the anode, if the fuel gas supply is insufficient, for example, during an initial stage of operation, a voltage drop or concentration polarization occurs at that part, which may result in a local potential having a polarity opposite to that of the normal potential, and thus an electrochemical oxidative decomposition reaction of carbon.

An electrode material that uses titanium oxide (TiO₂), which is an electron conducting oxide thermodynamically stable under the PEFC operating conditions (strong acidity, high potential), as a support to solve the problem of corrosion of the carbon support described above, has been reported. For example, Patent Document 3 describes a fuel cell electrode material in which electrode catalyst composite bodies formed of nano size fine particles are supported on a carbon support. In Patent Document 3, a hydrophobic acetylacetonate compound is used as a raw material, and Pt and an electron conducting oxide (TiO₂) are simultaneously produced to suppress particle growth of each of Pt and TiO₂.

### CITATION LIST

### Patent Document

Patent Document 1: JP 6969996 B
Patent Document 2: JP 6931808 B
Patent Document 3: JP 2020-161272 A

### SUMMARY OF INVENTION

### Technical Problem

Patent Documents 1 and 2 claim that the electrode materials disclosed therein in which Pt fine particles are supported in the pores (mesopores) of mesoporous carbon, have a low risk of aggregation of the Pt fine particles. However, in the electrode materials of Patent Documents 1 and 2, the Pt fine particles are supported in direct contact with wall surfaces of pores of the mesoporous carbon, and thus carbon corrosion cannot be avoided. Thus, the electrode materials of Patent Documents 1 and 2 cannot prevent aggregation, detachment, and the like of the Pt particles due to carbon corrosion, if power generation is performed for a long period of time.

In addition, in the electrode material of Patent Document 3, TiO₂ included in the electrode catalyst composite bodies supported on the carbon support is excellent in durability under the PEFC operating conditions, but does not have sufficiently high electron conductivity. Therefore, the electrode catalyst composite bodies including TiO₂ have insufficient electron conductivity, and have room for improvement for obtaining practical electrode performance.

Under such circumstances, an object of the present invention is to provide an electrode material from which an electrode having excellent electrode performance can be produced, and an electrode, a membrane electrode assembly, and a polymer electrolyte fuel cell using the electrode material.

### Solution to Problem

As a result of diligent studies to solve the above problems, the present inventors have found that the following aspects satisfy the above object, and have completed the present invention.

That is, the present invention relates to the following aspects.

<1A> An electrode material, including,
a porous composite support including,
a carbon support formed of mesoporous carbon, the mesoporous carbon having an internal surface inside pores and an external surface outside the pores, and
an electron conducting oxide adhered to at least the internal surface inside the pores of the mesoporous carbon, and
electrode catalyst particles supported on the porous composite support, in which
some or all of the electrode catalyst particles are supported via the electron conducting oxide in the pores of the mesoporous carbon.

<2A> The electrode material according to <1A>, in which the mesoporous carbon has interconnected pores formed by interconnection between some or all of pores in a mesopore region and an adjacent pore in the mesopore region.

<3A> The electrode material according to <1A> or <2A>, in which a pore size of the mesoporous carbon is 3 nm or more and 40 nm or less.

<4A> The electrode material according to any one of <1A> to <3A>, in which the electron conducting oxide is an electron conducting oxide containing tin oxide as a main component.

<5A> The electrode material according to any one of <1A> to <4A>, in which the electron conducting oxide includes a niobium-doped tin oxide.

<6A> The electrode material according to any one of <1A> to <5A>, in which in the mesoporous carbon, a particle size of the electron conducting oxide adhered to the internal surface inside the pores is 0.5 nm or more and 3 nm or less.

<7A> The electrode material according to any one of <1A> to <6A>, in which the electrode catalyst particles are particles of Pt or an alloy containing Pt.

<8A> An electrode, including,
the electrode material according to any one of <1A> to <7A>, and
a proton conducting electrolyte material.

<9A> A membrane electrode assembly, including,
a solid polymer electrolyte membrane,
a cathode bonded to one surface of the solid polymer electrolyte membrane, and
an anode bonded to the other surface of the solid polymer electrolyte membrane, in which
one or both of the anode and the cathode are the electrode according to <8A>.

<10A> A polymer electrolyte fuel cell, including the membrane electrode assembly according to <9A>.

<11A> A method for producing the electrode material according to <1A>, including,
(1A) mixing, in a non-aqueous organic solvent, mesoporous carbon being a carbon support and an alkoxide compound being an electron conducting oxide precursor, to form a uniform mixture, and then distilling off the solvent to dry the mixture,
(2A) subjecting the dried product obtained in (1A) to a steam treatment to decompose the electron conducting oxide precursor, and then subjecting the resultant product to a heat treatment to obtain a porous composite support including the electron conducting oxide adhered to a surface of the porous composite support,
(3A) mixing the porous composite support obtained in (2A) and a solution containing an electrode catalyst precursor to form a uniform mixture, and then distilling off the solvent to obtain a dried product, and
(4A) subjecting the dried product obtained in (3A) to a heat treatment in an inert gas atmosphere.

<1B> An electrode material, including,
a carbon support formed of mesoporous carbon, the mesoporous carbon having an internal surface inside pores and an external surface outside the pores, and
an electrode catalyst composite body adhered to at least the internal surface inside the pores of the mesoporous carbon, in which
the electrode catalyst composite body includes electrode catalyst particles and an electron conducting oxide, and
the electron conducting oxide fills gaps between the electrode catalyst particles.

<2B> The electrode material according to <1B>, in which the mesoporous carbon has interconnected pores formed by interconnection between some or all of pores in a mesopore region and an adjacent pore in the mesopore region.

<3B> The electrode material according to <1B> or <2B>, in which a pore size of the mesoporous carbon is 3 nm or more and 40 nm or less.

<4B> The electrode material according to any one of <1B> to <3B>, in which the electron conducting oxide is an electron conducting oxide containing tin oxide as a main component.

<5B> The electrode material according to any one of <1B> to <4B>, in which the electron conducting oxide includes a niobium-doped tin oxide.

<6B> The electrode material according to any one of <1B> to <5B>, in which the electrode catalyst particles included in the electrode catalyst composite body have a particle size of 1 nm or more and 10 nm or less.

<7B> The electrode material according to any one of <1B> to <6B>, in which the electron conducting oxide included in the electrode catalyst composite body is partly or completely crystalline.

<8B> The electrode material according to any one of <1B> to <7B>, in which the electrode catalyst particles are particles of Pt or an alloy containing Pt.

<9B> An electrode, including,
the electrode material according to any one of <1B> to <8B>, and
a proton conducting electrolyte material.

<10B> A membrane electrode assembly, including,
a solid polymer electrolyte membrane,
a cathode bonded to one surface of the solid polymer electrolyte membrane, and
an anode bonded to the other surface of the solid polymer electrolyte membrane, in which
one or both of the anode and the cathode are the electrode according to <9B>.

<11B> A polymer electrolyte fuel cell, including the membrane electrode assembly according to <10B>.

<12B> A method for producing the electrode material according to <1B>, including,
(1B) dissolving an acetylacetonate compound being an electrode catalyst metal precursor and an acetylacetonate compound being an electron conducting oxide precursor, in a dispersion prepared by dispersing mesoporous carbon being a carbon support in a hydrophobic organic solvent, stirring the dispersion, and distilling off the solvent to obtain the mesoporous carbon on which the electrode catalyst metal precursor and the electron conducting oxide precursor are supported, and
(2B) subjecting, to a heat treatment in an inert gas atmosphere, the mesoporous carbon obtained in step (1B) on which the electrode catalyst metal precursor and the electron conducting oxide precursor are supported, to form an electrode catalyst composite body.

<1C> An electrode material, including,
a carbon support, and
an electrode catalyst composite body supported via an electron conducting oxide layer on a surface of the carbon support, in which
the carbon support is mesoporous carbon or particulate solid carbon, and
the electrode catalyst composite body includes electrode catalyst particles and an electron conducting oxide, and the electron conducting oxide fills gaps between the electrode catalyst particles.

<2C> The electrode material according to <1C>, in which the electron conducting oxide layer includes an electron conducting oxide containing, as a main component, an oxide of a metal element selected from tin (Sn), molybdenum (Mo), niobium (Nb), tantalum (Ta), titanium (Ti), and tungsten (W).

<3C> The electrode material according to <2C>, in which the electron conducting oxide layer includes a niobium-doped tin oxide.

<4C> The electrode material according to any one of <1C> to <3C>, in which the electrode catalyst particles included in the electrode catalyst composite body include Pt or an alloy containing Pt.

<5C> The electrode material according to any one of <1C> to <4C>, in which the electrode catalyst particles included in the electrode catalyst composite body have a particle size of 1 nm or more and 10 nm or less.

<6C> The electrode material according to any one of <1C> to <5C>, in which the electron conducting oxide included in the electrode catalyst composite body is an electron conducting oxide containing tin oxide as a main component.

<7C> The electrode material according to <6C>, in which the electron conducting oxide included in the electrode catalyst composite body includes a niobium-doped tin oxide.

<8C> The electrode material according to any one of <1C> to <7C>, in which the electron conducting oxide included in the electrode catalyst composite body is partly or completely crystalline.

<9C> An electrode, including,
the electrode material according to any one of <1C> to <8C>, and
a proton conducting electrolyte material.

<10C> A membrane electrode assembly, including,
a solid polymer electrolyte membrane,
a cathode bonded to one surface of the solid polymer electrolyte membrane, and
an anode bonded to the other surface of the solid polymer electrolyte membrane, in which
one or both of the anode and the cathode are the electrode according to <9C>.

<11C> A polymer electrolyte fuel cell, including the membrane electrode assembly according to <10C>.

<12C> A method for producing the electrode material according to <1C>, including,
(1C) forming an electron conducting oxide layer on a carbon support,
(2C) dissolving an acetylacetonate compound being an electrode catalyst metal precursor and an acetylacetonate compound being an electron conducting oxide precursor, in a dispersion prepared by dispersing, in a hydrophobic organic solvent, the carbon support obtained in step (1C) on which the electron conducting oxide layer is formed, stirring the dispersion, and distilling off the solvent to obtain the carbon support on which the electron conducting oxide layer is formed and the electrode catalyst metal precursor and the electron conducting oxide precursor are supported, and
(3C) subjecting, to a heat treatment in an inert gas atmosphere, the carbon support obtained in step (2C) on which the electrode catalyst metal precursor and the electron conducting oxide precursor are supported, to form an electrode catalyst composite body.

### Advantageous Effects of Invention

According to the present invention, there are provided an electrode material from which an electrode having excellent electrode performance can be produced, and an electrode, a membrane electrode assembly, and a polymer electrolyte fuel cell using the electrode material.

### BRIEF DESCRIPTION OF DRAWINGS

FIG. 1A is a conceptual schematic diagram of an electrode material according to one embodiment of the present invention. (a) in FIG. 1A is a conceptual schematic diagram of the electrode material (A), (b) in FIG. 1A is an enlarged schematic diagram of a pore and the vicinity of the pore (with dispersively adhered electron conducting oxide), and (c) in FIG. 1A is an enlarged schematic diagram of a pore and the vicinity of the pore (with continuously adhered electron conducting oxide (covered by the electron conducting oxide)).

FIG. 1B is a conceptual schematic diagram of an electrode material according to another embodiment of the present invention. (a) in FIG. 1B is a conceptual schematic diagram of an electrode material (B), and (b) in FIG. 1B is an enlarged schematic diagram of a pore and the vicinity of the pore.

FIG. 1C is a conceptual schematic diagram of an electrode material according to another embodiment of the present invention. (a) in FIG. 1C is a conceptual schematic diagram of an electrode material (C), (b) in FIG. 1C is an enlarged schematic diagram of a surface, and (c) in FIG. 1C is an enlarged schematic diagram of a pore and the vicinity of the pore.

FIG. 2 is a schematic cross-sectional view of a membrane electrode assembly according to one embodiment of the present invention.

FIG. 3 is a conceptual diagram illustrating a typical configuration of a polymer electrolyte fuel cell of the present invention.

FIG. 4 is a flowchart of a procedure for preparing an electrode material of Example (not loaded with electrode catalyst).

FIG. 5 shows an electrode material according to one embodiment. FIG. 5 is an FESEM image (left) and a STEM image (right) of an electrode material of Example 1A (not loaded with electrode catalyst, “Sn_{0.9}Nb_{0.1}O₂/MC”).

FIG. 6 shows an electrode material according to one embodiment. FIG. 6(a) is an (highly magnified) FESEM image of an electrode material of Example 2A (not loaded with electrode catalyst), and FIG. 6(b) is an enlarged image of a region indicated by a dashed line in FIG. 6(a) (inside of a pore (mesopore)).

FIG. 7 is an image of electron conducting oxide in a pore (mesopore) of mesoporous carbon.

FIG. 8 shows an FESEM image (left) and a STEM image (right) of the electrode material of Example 1A (Pt/Sn_{0.9}Nb_{0.1}O₂/MC).

FIG. 9 shows an FESEM image (left) and a STEM image (right) of an electrode material of Comparative Example 1 (Pt/MC).

FIG. 10 shows STEM images. (a) in FIG. 10 is a STEM image of an external surface of the electrode material of Example 2A (loaded with Pt, “Pt/Sn_{0.98}Nb_{0.02}O₂/MC”), and (b) in FIG. 10 is a STEM image of the inside of a mesopore of the electrode material of Example 2A.

FIG. 11 shows cyclic voltammograms (CV) of the electrode material of Example 1A (Pt/Sn_{0.9}Nb_{0.1}O₂/MC) and the electrode material of Comparative Example 1 (Pt/MC).

FIG. 12 shows linear sweep voltammograms (1600 rpm) of the electrode materials of Example 1A and Comparative Example 1.

FIG. 13 is a diagram showing conditions of a start-stop cycle test.

FIG. 14 shows changes in ECSA (relative values) of the electrode materials of Example 1A and Comparative Example 1 during the start-stop cycle test.

FIG. 15 shows FESEM images (upper images) and STEM images (lower images) of the electrode material of Comparative Example 1 (Pt/MC) before and after the start-stop cycle test (20,000 cycles).

FIG. 16 shows FESEM images (upper images) and STEM images (lower images) of the electrode material of Example 1A (Pt/Sn_{0.9}Nb_{0.1}O₂/MC) before and after the start-stop cycle test (60,000 cycles).

FIG. 17 is a flowchart of a procedure for preparing electrode materials of Experimental Example 1B and Experimental Example 2B.

FIG. 18 shows heat treatment conditions for preparation of the electrode materials of Experimental Examples.

FIG. 19 shows X-ray diffraction (XRD) patterns of the electrode materials of Experimental Examples (Experimental Example 1B: Pt—SnO₂/MC, Experimental Example A2: Pt—SnO₂/CB (Vulcan)).

FIG. 20 shows a scanning transmission electron microscope (STEM) image and EDS mapping of the electrode material of Experimental Example 2B (Pt—SnO₂/CB (Vulcan)).

FIG. 21 shows a high-angle annular dark-field scanning transmission electron microscopy (HAADF-STEM) image of the electrode material of Experimental Example 2B.

FIG. 22 is a STEM image and EDS mapping of the electrode material of Experimental Example 1B (Pt—SnO₂/MC).

FIG. 23 is a HAADF-STEM image of the electrode material of Experimental Example 1B.

FIG. 24 shows STEM images of the electrode material of Experimental Example 1B (Pt—SnO₂/MC). FIG. 24(a) shows a front surface of MC (0 nm), FIG. 24(b) shows the inside of a mesopore (−170 nm), FIG. 24(c) shows the inside of the mesopore (−290 nm), and FIG. 24(d) shows a back surface of MC (−414 nm) (values indicated in parentheses are focal lengths when the focal length for the MC surface is defined as 0 nm).

FIG. 25 shows cyclic voltammograms (CV) of the electrode material of Experimental Example 1B (Pt—SnO₂/MC) and the electrode material of Experimental Example 2B (Pt—SnO₂/CB (Vulcan)).

FIG. 26 is linear sweep voltammograms (LSV, 1600 rpm) of the electrode materials of Experimental Example 1B and Experimental Example 2B.

FIG. 27 shows LSVs (1600 rpm) of the electrode materials of Experimental Example 1B and Comparative Example 1 before and after a start-stop cycle test (Experimental Example 1B: Pt—SnO₂/MC, Comparative Example 1: Pt/MC).

FIG. 28 is a diagram showing conditions of a load fluctuation cycle test.

FIG. 29 shows LSVs (1600 rpm) of the electrode materials of Experimental Example 1B and Comparative Example 1 before and after the load fluctuation cycle test (Experimental Example 1B: Pt—SnO₂/MC, Comparative Example 1: Pt/MC).

FIG. 30 shows XRD patterns of electrode materials of Experimental Examples (Experimental Example 1C: Pt—SnO₂/Sn(Nb)O₂/GCB, Experimental Example 2C: Pt—SnO₂/Sn(Nb)O₂/CB (Vulcan)).

FIG. 31 is a field emission scanning electron microscope (FESEM) image of an electrode material of Experimental Example 1C (Pt—SnO₂/Sn(Nb)O₂/GCB).

FIG. 32 is an FESEM image of an electrode material of Experimental Example 2C (Pt—SnO₂/Sn(Nb)O₂/CB (Vulcan)).

FIG. 33 is a diagram showing changes in ECSA of the electrode materials of Experimental Example 1C and Comparative Example 2 in the start-stop cycle test (Experimental Example 1C: Pt—SnO₂/Sn(Nb)O₂/GCB, Comparative Example 2: Pt/C (manufactured by Tanaka Kikinzoku Kogyo, TEC10E50E)).

### REFERENCE SIGNS LIST

1A, 1B, 1C Electrode material
2 Carbon support (mesoporous carbon)
2A Carbon support (solid carbon)
2a Internal surface inside pores
2b External surface outside pores
2c Electron conducting oxide layer
3 Electrode catalyst composite body
3a Electron conducting oxide
3b Electrode catalyst particle
4 Electrode (cathode)
4a Electrode catalyst layer (cathode)
4b Gas diffusion layer
5 Electrode (anode)
5a Electrode catalyst layer (anode)
5b Gas diffusion layer
6 Solid polymer electrolyte membrane
10 Membrane electrode assembly (MEA)
20 Polymer electrolyte fuel cell
21 External circuit
P Pore (mesopore)

### DESCRIPTION OF EMBODIMENTS

Hereinafter, the present invention will be described in detail with reference to examples and the like. Note that the present invention is not limited to embodiments described below and can be freely modified and implemented without departing from the gist of the present invention. Dimensions, materials, other specific numerical values, and the like indicated in the embodiments are merely examples for facilitating understanding of the invention, and should not be construed as limitation for the present invention unless otherwise noted.

In addition, in all the drawings, the same constituent elements are denoted by the same reference numerals, and description thereof may be omitted. In the present specification, “from . . . to . . . ” or “ . . . to . . . ” is used as an expression including numerical values before and after “to”.

### Definition of Terms, Etc.

A “carbon support” as used herein means a porous carbon material serving as a skeleton (base) of an electrode material.

A “pore” as used herein includes, for example, a hole having a diameter of 150 nm or less (particularly, a hole having a diameter of 100 nm or less). A “pore in the mesopore region” means a pore having a diameter of from 2 nm to 50 nm. In addition, as used herein, a “pore in the micropore region” means a pore having a diameter less than 2 nm, and a “pore in the macropore region” means a pore having a diameter greater than 50 nm and equal to or less than 150 nm.

In addition, as used herein, a “M oxide” (M is a metal element) is not limited to the M oxide in a crystal form, and includes M oxides in a crystal form, an amorphous form, and in a mixture of a crystal form and an amorphous form. For example, Sn oxides include SnO₂ crystal, oxygen non-stoichiometric oxides (referred to as “SnOx”), and mixtures thereof.

In addition, in the present specification, a cathode condition of the polymer electrolyte fuel cell (PEFC) is a condition in the cathode during normal operation of the PEFC and means a condition in which a temperature is about room temperature to about 150° C. and a gas containing oxygen such as air is supplied (oxidizing atmosphere), and an anode condition is a condition in the anode during normal operation of the PEFC and means a condition in which a temperature is about room temperature to about 150° C. and a fuel gas containing hydrogen is supplied (reducing atmosphere).

### 1. Electrode Material

The present invention relates to the following electrode material (A) and electrode material (B).

The electrode material (A):
an electrode material, including,
a porous composite support including,
a carbon support formed of mesoporous carbon, the mesoporous carbon having an internal surface inside pores and an external surface outside the pores, and
an electron conducting oxide adhered to at least the internal surface inside pores of the mesoporous carbon, and
electrode catalyst particles supported on the porous composite support, in which
some or all of the electrode catalyst particles are supported via the electron conducting oxide in pores of the mesoporous carbon.

The electrode material (B):
an electrode material, including,
a carbon support formed of mesoporous carbon, the mesoporous carbon having an internal surface inside pores and an external surface outside the pores, and
an electrode catalyst composite body adhered to at least the internal surface inside pores of the mesoporous carbon, in which
the electrode catalyst composite body includes electrode catalyst particles and an electron conducting oxide, and
the electron conducting oxide fills gaps between the electrode catalyst particles.

Here, “adherence” means that the electron conducting oxide (for an electrode catalyst (A)) or the electrode catalyst composite body (for an electrode catalyst (B)) is fixed to an internal surface inside pores or an external surface outside pores of the carbon support and is not easily detached (peeled off).

In the electrode material (A), the electron conducting oxide is adhered so as to cover partly or completely the internal surfaces of pores in the mesopore region in the mesoporous carbon, and the electrode catalyst particles are supported by the electron conducting oxide. That is, the electrode catalyst particles are supported via the electron conducting oxide in the pores in the mesopore region of the mesoporous carbon. Note that, in the electrode material (A), the electrode catalyst particles may be supported not only in the pores in the mesopore region but also in pores other than the pores in the mesopore region or on the external surface, via the electron conducting oxide.

The form of the adhered electron conducting oxide may be any form such as a particle form, an island form, or a thin film form as long as the object of the present invention is not impaired. The “island form” means a state in which clumps formed by several particles of the electron conducting oxide are separated from each other, and “film form” means a state in which the electron conducting oxide is continuously connected to form a thin film.

In the electrode material (B), the electrode catalyst composite body including the electrode catalyst particles and the electron conducting oxide is adhered so as to cover partly or completely the internal surface inside pores in the mesopore region in the mesoporous carbon. Note that, in the electrode material (B), the electrode catalyst composite body may be adhered not only in the pores in the mesopore region but also in pores other than the pores in the mesopore region or on the external surface.

The form of the adhered electrode catalyst composite body may be any form such as a particle form, an island form, or a thin film form as long as the object of the present invention is not impaired. The “island form” means a state in which clumps formed by several particulate electrode catalyst composite bodies are separated from each other, and “film form” means a state in which the electrode catalyst composite bodies are continuously connected to form a thin film.

A first aspect (the electrode material (A)) and a second aspect (the electrode material (B)) of the electrode material of the present invention are both characterized in that “mesoporous carbon is used as a carbon support which forms a skeleton of the electrode material, and the electrode catalyst particles and the electron conducting oxide are present in pores of the mesoporous carbon”.

In addition, the electrode material (A) is characterized in that “some or all of the electrode catalyst particles are supported via the electron conducting oxide in the pores of the mesoporous carbon”, whereas the electrode material (B) is characterized in that “some or all of the electrode catalyst particles are adhered as the electrode catalyst composite body in the pores of the mesoporous carbon”. In these respects, the electrode material (A) and the electrode material (B) are different from each other.

The present invention also relates to the following electrode material (C).

The electrode material (C):
an electrode material, including,
a carbon support, and
an electrode catalyst composite body supported via an electron conducting oxide layer on a surface of the carbon support, in which
the carbon support is mesoporous carbon or particulate solid carbon, and
the electrode catalyst composite body includes electrode catalyst particles and an electron conducting oxide, and the electron conducting oxide fills gaps between the electrode catalyst particles.

The electrode material (C) is characterized in that the electrode material (C) has an electron conducting oxide layer on a surface of the carbon support (internal surface inside pores and/or an external surface outside pores), and the electrode catalyst composite body is adhered to the carbon support via the electron conducting oxide layer.

When the electrode material (C) includes the carbon support being mesoporous carbon, the electrode material (C) is characterized, as in the electrode material (A) and the electrode material (B), in that “mesoporous carbon is used as a carbon support which forms a skeleton of the electrode material, and the electrode catalyst particles and the electron conducting oxide are present in pores of the mesoporous carbon”.

In the following description, the electrode material (A) may be referred to as an electrode material of the present invention (first aspect), the electrode material (B) may be referred to as an electrode material of the present invention (second aspect), and the electrode material (C) may be referred to as an electrode material of the present invention (third aspect). In addition, the electrode materials (A) to (C) may be collectively referred to as “electrode materials of the present invention”.

The electrode materials of the present invention (the electrode materials (A) to (C)) exhibit common characteristic effects that electrode catalyst particles are prevented from aggregating to form a large mass and both of excellent durability against electrochemical oxidation imparted by the electron conducting oxide and excellent electron conductivity imparted by the carbon material are achieved.

The electrode material of the present invention is suitable as an electrode material used for an electrode of a polymer electrolyte fuel cell, but can also be used for other applications (for example, an electrode for polymer electrolyte membrane water electrolysis).

Hereinafter, preferred embodiments of the present invention will be described in detail with reference to the drawings. In the following description, it is assumed that the electrode material of the present invention is used for an electrode for a polymer electrolyte fuel cell (PEFC).

### Electrode Material (A)

Hereinafter, the electrode material (A) which is the first aspect of the electrode material of the present invention will be described.

As described above, the electrode material (A) is an electrode material, including, a porous composite support including, a carbon support formed of mesoporous carbon having an internal surface inside pores and an external surface outside the pores, and an electron conducting oxide adhered to at least the internal surface inside the pores of the mesoporous carbon, and
electrode catalyst particles supported on the porous composite support, in which some or all of the electrode catalyst particles are supported via the electron conducting oxide in the pores of the mesoporous carbon.

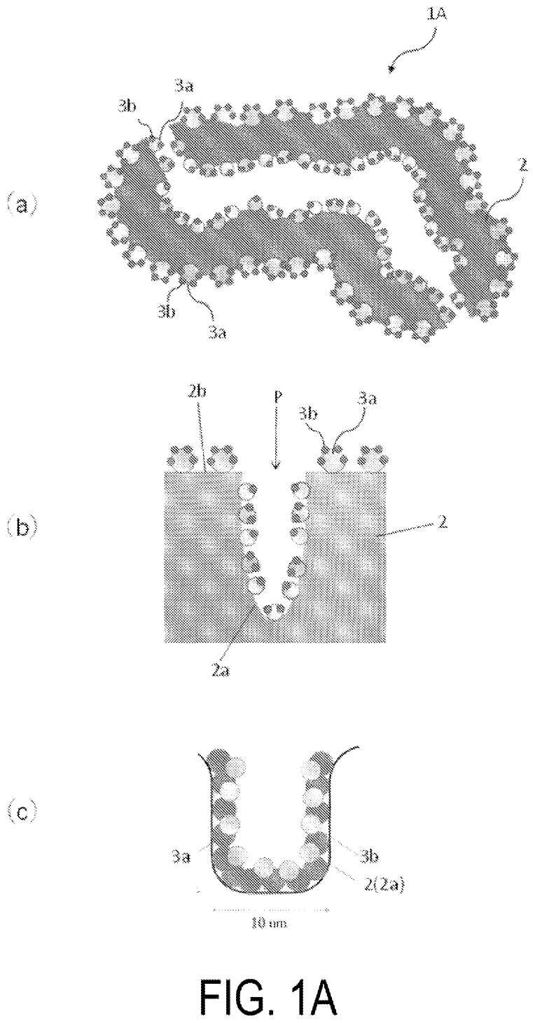

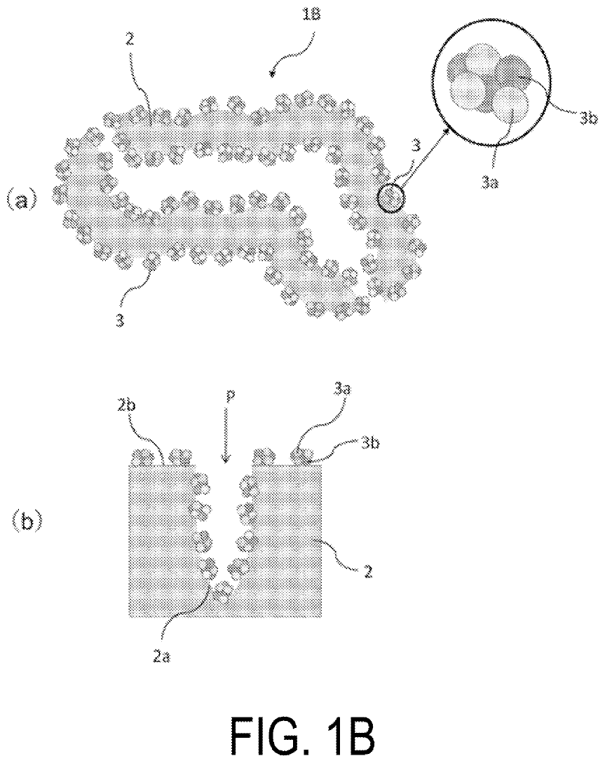

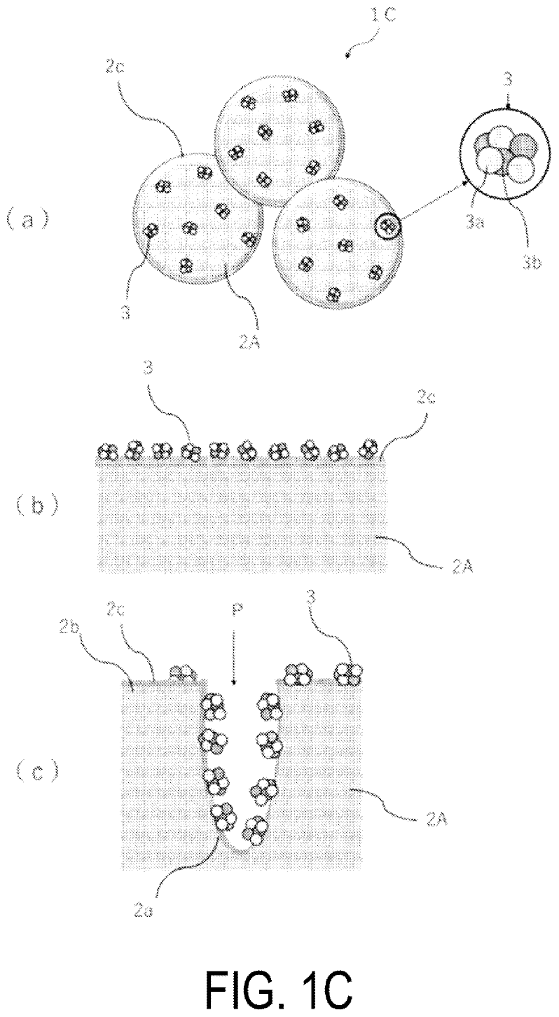

FIG. 1A(a) is a schematic diagram illustrating a representative configuration of the electrode material (A), and FIGS. 1A(b) and 1A(c) are enlarged schematic diagrams of a pore and the vicinity of the pore.

As illustrated in FIG. 1A(a), an electrode material 1A according to the present invention includes a porous composite support including mesoporous carbon 2 as a carbon support and particulate electron conducting oxide 3a adhered to the mesoporous carbon 2 (an internal surface 2a inside pores and an external surface 2b outside the pores), and electrode catalyst particles 3b supported on the electron conducting oxide 3a.

Although the external surface 2b of the electrode material 1A illustrated in FIG. 1A(a) also has the electron conducting oxide 3a and electrode catalyst particles 3b dispersively supported thereon, the electron conducting oxide 3a and the electrode catalyst particles 3b may be present only on the internal surface 2a inside the pores.

The mesoporous carbon 2 (hereinafter, which may be referred to as “mesoporous carbon according to the present invention”), which is the skeleton of the 1A of the electrode material, is porous carbon having a large number of pores in the mesopore region.

As the mesoporous carbon 2, porous carbon having pores in the mesopore region (from 2 to 50 nm) can be used, and the pore size of 3 nm or more and 40 nm or less is preferable. The pore size within this range ensures that substance diffusion into the pores smoothly occurs without significant inhibition, even when the electron conducting oxide and the electrode catalyst are adhered to (supported on) the inner wall of the pore.

As described below, production of a fuel cell electrode involves mixing the electrode material of the present invention with a proton conducting electrolyte material (ionomer). The proton conducting electrolyte material (ionomer) has a size of several tens of nm, and thus cannot enter mesopores having a small pore size. Thus, the pore size within the above range can suppress ionomer poisoning of the electrode catalyst metal supported by the electron conducting oxide in the pores of the mesoporous carbon.

The mesoporous carbon according to the present invention may include pores in other regions (the micropore region, macropores), i.e., pores not in the mesopore region (from 2 nm to 50 nm), but preferably has a large proportion of the pores in the mesopore region.

The structure (pore size, shape, etc.) of the pores of the mesoporous carbon can be observed with an electron microscope. Examples of the electron microscope include a field emission scanning electron microscope (FESEM) and a scanning transmission electron microscope (STEM).

It is preferable that the pores in the mesopore region of the mesoporous carbon 2 include not only isolated pores independent of other pores but also include interconnected pores formed by interconnection between some or all of pores in the mesopore region and an adjacent pore in the mesopore region, and thus have a three dimensional network structure. The presence of the interconnected pores facilitates diffusion of substances inside the pores of the mesoporous carbon.

The size and shape of the electrode material 1A depend on the size and shape of the mesoporous carbon which is a skeletal material. The size and shape of the mesoporous carbon are determined such that, in a fuel cell electrode formed using the electrode material, the electrode material can continuously contact with each other, and spaces that allow gases such as hydrogen and oxygen in the fuel cell electrode to be smoothly diffused and allow water (steam) to be smoothly discharged can be formed.

The mesoporous carbon used as an electrode material for the fuel cell electrode of the present invention may be appropriately synthesized, or a commercially available product. Examples of the commercially available product include CNovel series (designed mesopore size: from 5 to 150 nm) manufactured by Toyo Tanso Co., Ltd., which is mesoporous carbon produced by using MgO as a mold.

### Electron Conducting Oxide

As illustrated in FIG. 1A, in the electrode material 1A of the present embodiment, the electron conducting oxide 3a is adhered to the internal surface 2a of the pores in the mesopore region of the mesoporous carbon 2. In the electrode material 1A of the present embodiment, the electron conducting oxide 3a is also adhered to the external surface of the mesoporous carbon 2. However, the electron conducting oxide 3a on the external surface is not essential.

The optimum amount of the electron conducting oxide adhered varies depending on the physical properties of the electron conducting oxide such as the particle size (or the film thickness in the case of a thin film) and the surface area, and/or the method for producing the electron conducting oxide, and thus the amount of the electron conducting oxide adhered is appropriately determined within a range in which a sufficient amount of electrode catalyst particles can be supported.

The size of the electron conducting oxide in the pores is determined to be a size such that the electron conducting oxide does not block the pores of the mesoporous carbon 2 and does not inhibit transfer of a substance, such as a gas. While in part depending on the pore size of the mesoporous carbon 2, the particle size of the electron conducting oxide adhered to the internal surfaces of the pores is preferably 0.5 nm or more and 3 nm or less.

The electron conducting oxide 3a on the external surface is substantially irrelevant to blockage of the mesopores, and thus may be larger than the electron conducting oxide in the pores. However, the electron conducting oxide 3a on the external surface preferably has a small particle size as long as the electrode catalyst particles 3b can be dispersively supported, because such a small particle size contributes to reduce the electrical resistance. The electron conducting oxide on the external surface, if present, preferably has a size of 0.5 nm or more and 10 nm or less.

The “average particle size of the particulate electron conducting oxide” can be obtained from an average value of particle sizes of randomly selected particulate electron conducting oxide (20 particles) observable in an electron microscope image.

In FIGS. 1A(a) and 1A(b), the electron conducting oxide 3a is particulate electron conducting oxide dispersively adhered to the mesoporous carbon 2. However, the electron conducting oxide 3a is not limited thereto, as long as the electron conducting oxide 3a is adhered to the mesoporous carbon 2. For example, as illustrated in FIG. 1A(c), the electron conducting oxide 3a may be adhered so as to continuously cover the surface (particularly, the internal surface inside pores) of the mesoporous carbon 2, instead of being dispersed.

That is, in the electrode material (A) which is the first aspect of the electrode material of the present invention, the form of the adhered electron conducting oxide may be any form such as a particle form, an island form, or a thin film form as long as the object of the present invention is not impaired.

The electron conducting oxide 3a may include electron conducting oxide with both sufficient durability and electronic conductivity under at least one of the anode condition and cathode condition of fuel cells (particularly polymer electrolyte fuel cells).

Specific examples of the electron conducting oxide include electron conducting oxide containing, as a main component, one selected from tin oxide, molybdenum oxide, niobium oxide, tantalum oxide, titanium oxide, and tungsten oxide. In the present invention, “electron conducting oxide containing, as a main component, . . . ” includes (A) an oxide including only a matrix oxide, and (B) an oxide doped with another element and containing the matrix oxide in an amount of 80 mol % or more.

Specific examples of the element to be doped include Sn, Ti, Sb, Nb, Ta, W, In, V, Cr, Mn, and Mo (provided that the element is different from the element contained in the matrix oxide). The element to be doped is an element having a valence higher than that of the matrix oxide. For example, when the matrix oxide is titanium oxide, an element other than Ti (for example, Nb) is selected from the above-described dopants.

Among them, the electron conducting oxide 3a is preferably an oxide containing tin oxide as a main component. Here, “oxide containing oxide X as a main component” refers to oxide containing 50 mol % or more of the oxide X.

Here, when the electron conducting oxide is an oxide containing tin oxide as a main component, the fuel cell electrode of the present invention is preferably used as a cathode.

SnO₂ which is oxide of Tin (Sn) is thermodynamically stable and resistant to oxidative decomposition under the cathode condition of the PEFC. In addition, tin oxide has sufficient electron conductivity and can serve as a support supporting electrode catalyst particles (particularly noble metal particles) in a highly dispersed state.

When the fuel cell electrode of the present invention is used as an anode, the oxide containing tin oxide as a main component is not preferable, because such an oxide will be reduced to metal Sn under the anode condition of the PEFC.

Among oxides containing tin oxide as a main component, a niobium-doped tin oxide doped with from 0.1 to 20 mol % of niobium (Nb) are particularly preferable, because using such niobium-doped tin oxide makes it possible to form a fuel cell electrode having more excellent electrode performances.

### Electrode Catalyst Particles

The electrode catalyst particles 3b are selectively dispersed and supported on the electron conducting oxide 3a. Here, “selectively dispersed and supported on the electron conducting oxide” means that 80% or more, preferably 90% or more, and more preferably 95% or more (including 100%) of the total number of the electrode catalyst particles are supported on the electron conducting oxide. The proportion of the electrode catalyst particles supported on the electron conducting oxide can be evaluated by observing the fuel cell electrode material to be evaluated with an electron microscope, randomly selecting (100 or more) electrode catalyst particles, and counting the number of the electrode catalyst particles supported on the electron conducting oxide and the number of the electrode catalyst particles supported on the mesoporous carbon.

Any of noble metal catalysts and non-noble metal catalysts which can serve as an electrochemical catalyst for oxygen reduction (and hydrogen oxidation) can be used as the electrode catalyst particles 3b. The electrode catalyst particles 3b are preferably formed from a metal selected from noble metals such as Pt, Ru, Ir, Pd, Rh, Os, Au, and Ag, and noble-metal-containing alloys containing these noble metals. The “noble-metal-containing alloy” includes “an alloy including only the above-listed noble metals” and “an alloy including 10 mass % or more of any of the above-listed noble metal and another metal”. The “other metal” to be alloyed with a noble metal is not particularly limited, but preferred examples thereof include Co, Ni, W, Ta, Nb, and Sn, and one or more of these metals may be used. In addition, two or more of the above-mentioned noble metals and noble-metal-containing alloys, may be used in a phase-separated state. In the present specification, the above-mentioned noble metals and alloys containing these noble metals may be referred to as “electrode catalyst metals”.

Among the electrode catalyst metals, Pt and an alloy containing Pt are highly electrochemically catalytically active for oxygen reduction (and hydrogen oxidation) in a temperature range around 80° C., which is the operating temperature of the polymer electrolyte fuel cell, and thus can be particularly suitably used.

The shape of the electrode catalyst particles 3b is not particularly limited, and those having a shape similar to known electrode catalyst particles can be used. Specific examples of the shape include a spherical shape, an elliptical shape, a polyhedral shape, and a core-shell structure. The structure of the electrode catalyst particles 3b is not limited to a crystal and may be amorphous or a mixture of crystalline and amorphous forms.

A smaller size of the electrode catalyst particles 3b increases the effective surface area on which the electrochemical reaction proceeds, resulting in improvement of electrochemical catalytic activity. However, if the size of the electrode catalyst particles 3b is too small, the electrochemical reaction activity is lowered. Thus, the average particle size of the electrode catalyst particles 3b is preferably from 0.5 to 4 nm.

The “average particle size of the electrode catalyst particles” in the present invention can be obtained from an average value of particle sizes of electrode catalyst particles (20 particles) observable in an electron microscope image. In calculating the average particle size by using the electron microscope image, if a fine particle has a nonspherical shape, the length in the direction of the maximum length of the particle is used as the particle size.

The loading amount of the electrode catalyst particles is appropriately determined in consideration of conditions such as the type of the catalyst and the size (thickness) of the electron conducting oxide serving as the support. If the loading amount of the catalyst is too small, the electrode performance may be insufficient, and if the loading amount of the catalyst is too large, the electrode catalyst particles may aggregate and the performance may be lowered.

The loading amount of the electrode catalyst particles is preferably from 0.1 to 60 mass %, and more preferably from 0.5 to 20 mass % relative to the total weight of the electrode material. The loading amount of the electrode catalyst particles within these ranges can result in excellent catalyst activity per unit mass and desired electrode reaction activity commensurate with the loading amount.

The loading amount of the electrode catalyst particles is typically from 3 to 40 mass % relative to the electron conducting oxide. The loading amount of the electrode catalyst particles within such a range may result in excellent catalytic activity per unit mass, and a desired electrochemical catalytic activity commensurate with the loading amount.

A loading amount less than 3 mass % results in insufficient electrode reaction activity, and a loading amount more than 40 mass % increases the risk of aggregation of the electrode catalyst particles, which results in problematic decrease in the effective surface area for the electrochemical reaction of oxygen and hydrogen. The loading amount of the electrode catalyst particles can be determined by, for example, inductively coupled plasma emission spectrometry (ICP).

### Method for Producing Electrode Material (A)

A method for producing the above-described electrode material (A) of the present invention is not particularly limited, and a suitable method may be appropriately selected depending on the types of the mesoporous carbon, the electron conducting oxide, and the electrode catalyst particles to be included in the electrode material (A). Typically, a method including, loading the mesoporous carbon with the electron conducting oxide, and then loading the electron conducting oxide with the electrode catalyst particles, is employed.

A preferred example of the method for producing the electrode material (A) of the present invention (hereinafter, may be referred to as “production method (A) of the present invention”) includes steps (1A) to (4A) described below.
Step (1A): Mixing, in a non-aqueous organic solvent, mesoporous carbon being a carbon support and an alkoxide compound being an electron conducting oxide precursor, to form a uniform mixture, and then distilling off the solvent to dry the mixture
Step (2A): Subjecting the dried product obtained in the step (1A) to a steam treatment to decompose the electron conducting oxide precursor, and then subjecting the resultant product to a heat treatment to obtain a porous composite support including the electron conducting oxide adhered to a surface of the porous composite support
Step (3A): Mixing the porous composite support obtained in the step (2A) and a solution containing an electrode catalyst precursor to form a uniform mixture, and then distilling off the solvent to obtain a dried product
Step (4A): Subjecting the dried product obtained in the step (3A) to a heat treatment in an inert gas atmosphere

Hereinafter, the production method (A) of the present invention will be described in detail.

In the step (1A), the mesoporous carbon being a carbon support and the alkoxide compound being an electron conducting oxide precursor are mixed in a non-aqueous organic solvent to form a uniform mixture, and then the solvent is distilled off to dry the mixture.

As described above, the mesoporous carbon being a carbon support has pores in the mesopore region (having a diameter of from 2 nm to 50 nm), and aqueous solvents are difficult to enter the pores. The non-aqueous organic solvent can be used to cause the alkoxide compound to enter the pores.

Thus, by dissolving, in a non-aqueous organic solvent, the alkoxide compound used as the electron conducting oxide precursor, and mixing with the mesoporous carbon, and then distilling off the non-aqueous organic solvent, the mixture can be dried in a state where the alkoxide compound is adsorbed on the surface (particularly on the internal surface inside pores) of the mesoporous carbon.

As the electron conducting oxide precursor, an alkoxide compound containing a metal corresponding to the electron conducting oxide desired to be produced can be used.

For example, when the electron conducting oxide is a Sn oxide, tin methoxide, tin ethoxide, tin propoxide, tin butoxide, tin methoxyethoxide, and tin ethoxyethoxide can be used as the alkoxide compound. Among them, tin ethoxide is preferable.

For example, when the electron conducting oxide desired to be produced is Sn oxide containing niobium oxide, a niobium alkoxide compound may be used together with the tin alkoxide compound.

As the niobium alkoxide compound, niobium methoxide, niobium ethoxide, niobium propoxide, niobium butoxide, niobium methoxyethoxide and niobium ethoxyethoxide can be used. Among them, niobium ethoxide is preferable.

The non-aqueous organic solvent may be any non-aqueous organic solvent that does not react with the alkoxide compound, and examples thereof include acetone, acetylacetone, toluene, xylene, and kerosene.

It is preferable that the non-aqueous organic solvent is substantially free of water. As used herein, “substantially free of water” does not exclude the presence of a trace amount of water as an impurity contained in a hydrophilic solvent or the like, and includes the case where the proportion of water in the solvent is reduced to the extent possible by ordinary efforts made industrially by those skilled in the art.

The concentrations of the mesoporous carbon and the electron conducting oxide precursor may be appropriately determined to be concentrations such that the electrode material (A) can be produced.

Any method can be used to distill off the solvent as long as the object of the present invention is not impaired, but the solvent is preferably distilled off under reduced pressure.

In the step (2A), first, the dried product obtained in the step (1A) is subjected to a steam treatment to hydrolyze the electron conducting oxide precursor (the alkoxide compound) adsorbed on the surfaces (the internal surface inside pores, the external surface outside pores) of the mesoporous carbon. Here, the “steam treatment” means a reaction caused by contact with a gas containing steam.

Examples of the gas used for the steam treatment include an inert gas such as nitrogen, helium, or argon, and nitrogen is typically used.

The gas used for the steam treatment preferably includes from 0.5 to 90% (preferably from 1 to 20%) of steam.

After the hydrolysis by the steam treatment, a heat treatment is performed to convert the hydrolysate (mainly hydroxide) of the alkoxide compound into the desired electron conducting oxide.

The heat treatment temperature may be equal to or higher than a temperature such that the hydrolysate of the alkoxide compound changes to the oxide, and is appropriately selected in consideration of species of the electron conducting oxide and the precursor thereof.

In the case of Sn oxide, the heat treatment temperature is 350° C. or higher, preferably 400° C. or higher, and more preferably 500° C. or higher. The upper limit of the temperature is not more than 700° C., and preferably not more than 650° C.

The atmosphere at the heat treatment temperature may be an atmosphere which allows the hydrolysate of the alkoxide compound to be converted into the oxide and which does not affect the electron conducting oxide and the carbon support, and is typically atmosphere of an inert gas such as nitrogen, helium, or argon.

In the step (3A), the porous composite support obtained in the step (2A) and a solution containing an electrode catalyst precursor are mixed to form a uniform mixture, and then the solvent is distilled off to obtain a dried product. The step (3A) is a step for loading the precursor of the electrode catalyst particles, on the electron conducting oxide of the porous composite support (the mesoporous carbon on which the electron conducting oxide is adhered).

The electrode catalyst precursor in the step (3A) is not limited as long as the object of the present invention is not impaired. However, when some species of electrode catalyst precursors are used, the object of the present invention may not be achieved in terms of the particle size and dispersibility of electrode metal particles.

An electrode catalyst precursor suitable for producing electrode catalyst particles which are highly dispersed and have small particle sizes is an acetylacetonate compound of the electrode catalyst. After loading, on the porous composite support, an acetylacetonate compound as the electrode catalyst precursor, the electrode catalyst precursor is directly converted into the electrode catalyst particles. When this method is used, improvement in catalytic activity can expected, because the electrode catalyst precursor does not contain residual impurities.

In the acetylacetonate method, loading the electrode catalyst precursor can be achieved by dispersing the porous composite support in a solution prepared by dissolving an acetylacetonate compound of the electrode catalyst in an appropriate solvent such as dichloromethane, stirring the dispersion, and distilling off the solvent. This method can avoid contamination by impurities such as chlorine and sulfur and allows highly dispersive loading of nano-sized electrode catalyst particles which are uniform in terms of particle size distribution. Further, a strong oxidizing agent or a strong reducing agent is not used in the solution, and thus this method can advantageously avoid deterioration of the electron conducting oxide and the mesoporous carbon as the carbon support which are included in the porous composite support.

Examples of the acetylacetonate compound of the electrode catalyst include acetylacetonates of noble metals such as Pt, Ru, Ir, Pd, Rh, Os, Au, and Ag, and one or more of these compounds can be used. The solvent may be any organic solvent in which the noble metal acetylacetonate is dispersed, and typical examples thereof include dichloromethane and acetylacetone.

An example of a method for loading the electrode catalyst fine particles by the acetylacetonate method is a method including, placing, in a predetermined container, a conductive auxiliary material on which the electron conducting oxide is supported and a noble metal acetylacetonate, and stirring the mixture with an ultrasonic stirrer while cooling with ice until the solvent completely vaporizes.

In the step (4A), the dried product obtained in the step (3A) is subjected to a heat treatment in an inert gas atmosphere.

In the dried product obtained in the step (3A), electrode catalyst particulate bodies supported on the porous composite support may include non-stoichiometric metal oxide, and less active. Thus, due to the step (4A), the dried product is subjected to a heat treatment in an inert atmosphere such as nitrogen or argon or a hydrogen-containing reducing atmosphere to activate the electrochemical catalytic activity of the metal being the electrode catalyst.

The heat treatment condition is appropriately selected in part depending on the species of the electron conducting oxide, the metal as the electrode catalyst, and the precursor. For example, in the case of an electron conducting oxide that is unstable in a reducing atmosphere, such as tin oxide, when the electrode catalyst is Pt or a Pt alloy, the temperature of from 180 to 400° C., and preferably from 200 to 250° C. is typically used. If the temperature is too low, the activation of the metal serving as the electrode catalyst becomes insufficient, and if the temperature is too high, the electrode catalyst particles aggregate and the effective reaction surface area becomes too small. Steam may be added to the atmosphere if necessary.

### Electrode Material (B) and Electrode Material (C)

Hereinafter, the electrode material (B) and the electrode material (C) which are the second and third aspects of the electrode material of the present invention, respectively, will be described.

As described above, the electrode material (B) is an electrode material, including, a carbon support formed of mesoporous carbon having an internal surface inside pores and an external surface outside the pores, and
an electrode catalyst composite body adhered to at least the internal surface inside the pores of the mesoporous carbon, in which the electrode catalyst composite body includes electrode catalyst particles and an electron conducting oxide, and the electron conducting oxide fills gaps between the electrode catalyst particles.

FIG. 1B(a) is a conceptual schematic diagram illustrating a typical configuration of the electrode material (the second aspect) of the present invention, and FIG. 1B(b) is an enlarged schematic diagram illustrating a pore and the vicinity of the pore.

As illustrated in FIG. 1B(a), the electrode material 1B (the second aspect) according to the present invention includes mesoporous carbon being the carbon support 2 and electrode catalyst composite bodies 3 supported on (adhered to) the mesoporous carbon (the internal surface 2a inside pores and/or the external surface 2b outside pores). Although the external surface 2b of the electrode material 1B illustrated in FIG. 1B(a) also has the electrode catalyst composite bodies 3, the electrode catalyst composite bodies 3 may be present only on the internal surface 2a inside pores.

That is, in the electrode material (B) of the present invention, the electrode catalyst composite bodies 3 are supported on some or all of the internal surfaces inside the pores in the mesopore region of the mesoporous carbon.

In the electrode material (B) of the present invention, the electrode catalyst composite bodies 3 may be supported not only in the pores in the mesopore region but also in pores other than the pores in the mesopore region or on the external surface.

The electrode catalyst composite body 3 includes electrode catalyst particles and electron conducting oxide existing between the electrode catalyst particles. The electron conducting oxide placed so as to fill the gaps between the electrode catalyst particles can prevent the electrode catalyst metal from aggregating to form a large mass. The electrode catalyst composite bodies 3 are dispersively supported on the carbon support 2 (the mesoporous carbon), and the surface of the carbon support 2 (mesoporous carbon) is partially exposed. Therefore, in the electrode formed using the electrode material, the carbon supports 2 contact with each other to form a low-resistance conductive path, and thus the electrode has excellent electron conductivity.

Although in FIG. 1B, the electron conducting oxide present between the electrode catalyst particles are in the form of particles, the form of the electron conducting oxide is not limited to particles and may be formless as long as the electron conducting oxide fills the gaps between the electrode catalyst particles. In addition, the electron conducting oxide may be crystalline or amorphous, but it is preferable that the electron conducting oxide is partly crystalline (that is, a mixture of crystalline and amorphous forms), and it is more preferable that the electron conducting oxide is entirely crystalline.

The electrode material (C) is an electrode material, including, a carbon support having an internal surface inside pores and an external surface outside the pores, and an electrode catalyst composite body supported via an electron conducting oxide layer on at least the internal surface inside the pores of the carbon support, in which the carbon support is mesoporous carbon or particulate solid carbon, and the electrode catalyst composite body includes electrode catalyst particles and an electron conducting oxide, and the electron conducting oxide fills gaps between the electrode catalyst particles.

FIG. 1C(a) is a conceptual schematic diagram illustrating a typical configuration of the electrode material (C) (the third aspect) of the present invention, FIG. 1C(b) is an enlarged schematic diagram illustrating a surface and the vicinity of the surface, and FIG. 1C(c) is an enlarged schematic diagram illustrating a pore and the vicinity of the pore.

The electrode material (the third aspect) of the present invention is characterized by including an electron conducting oxide layer on the surface of the carbon support.

The electrode material 1C (the third aspect) of the present invention includes a particulate carbon support 2A on which the electron conducting oxide layer is formed and the electrode catalyst composite body 3 supported on the carbon support 2A.

The electrode catalyst composite body 3 includes electrode catalyst particles (typically fine particles) and electron conducting oxide existing between the electrode catalyst particles (the same as the electrode catalyst composite body 3 of the electrode material 1B (the second aspect) of the present invention). Although the carbon support 2A in FIG. 1C(a) is a particulate solid carbon, the carbon support is not limited thereto, and mesoporous carbon may be used as the electrode material (C).

The electron conducting oxide placed so as to fill the gaps between the electrode catalyst particles can prevent the electrode catalyst particles from aggregating to form a large mass.

The electrode catalyst composite bodies 3 are dispersively supported via an electron conducting oxide layer 2c on the carbon support 2A. In an electrode formed using the electrode material, the carbon supports 2A contact with each other with the electron conducting oxide layers 2c therebetween. In this situation, a low-resistance conductive path is formed because the electron conducting oxide layer 2c is thin (for example, 1 to 10 nm), and thus the electrode has excellent electronic conductivity.

Although the electron conducting oxide layer 2c in FIG. 1C is formed to entirely cover the carbon support 2A, the electron conducting oxide layer 2c may be formed to only partly cover the carbon support 2A. In this case, the electrode catalyst composite body 3 supported on the carbon support 2A without the intervening electron conducting oxide layer 2c may be present.

Although in FIG. 1C, the electron conducting oxide (preferably Sn oxide) present between the electrode catalyst particles are in the form of particles, the form of the electron conducting oxide is not limited to particles and may be formless as long as the electron conducting oxide fills the gaps between the electrode catalyst particles. In addition, the electron conducting oxide may be crystalline or amorphous, but it is preferable that the electron conducting oxide is partly crystalline (that is, a mixture of crystalline and amorphous forms), and it is more preferable that the electron conducting oxide is entirely crystalline.

In the electrode material (C), the carbon support including the electron conducting oxide layer serves as the skeleton of the electrode, and thus the particle size of the electrode catalyst composite body can be reduced. Thus, in the electrode formed using the electrode material of the present invention, it is possible to reduce electrical resistance by the electron conducting oxide included in the electrode catalyst composite body.

As described above, in the electrode material (B) and the electrode material (C) of the present invention, the electron conducting oxide (preferably Sn oxide) present between the electrode catalyst particles suppress aggregation of the electrode catalyst particles. In addition, the electrode materials (B) and (C) are highly resistant against electrochemical oxidation because of the presence of the electron conducting oxide (preferably Sn oxide) and highly electronically conductive because of the use of the carbon support. Thus, an electrode formed using the electrode material exhibits excellent electrode performance, has high durability, and can generate power for a long period of time.

Hereinafter, constituent elements of the electrode material (B) and the electrode material (C) of the present invention will be described in detail. In the following description, it is assumed that the electrode material of the present invention is used for an electrode for a polymer electrolyte fuel cell (PEFC). However, use of the electrode material of the present invention is not limited to this application.

### Carbon Support

In the electrode material of the present invention, the carbon support is included in the electrode material of the present invention, has, in an electrode formed using the electrode material, roles of improving electron conductivity and serving as a skeleton of the electrode.

The carbon support in the electrode material (B) is mesoporous carbon.

As the mesoporous carbon, porous carbon having pores in the mesopore region (from 2 to 50 nm) can be used, and the pore size of 3 nm or more and 40 nm or less is preferable. The pore size within this range ensures that substance diffusion into the pores smoothly occurs without significant inhibition, even when the electron conducting oxide and the electrode catalyst are adhered to (supported on) the inner wall of the pore.

As described below, production of a fuel cell electrode involves mixing the electrode material of the present invention with a proton conducting electrolyte material (ionomer). The proton conducting electrolyte material (ionomer) has a size of several tens of nm, and thus cannot enter mesopores having a small pore size. Thus, the pore size within the above range can suppress ionomer poisoning of the electrode catalyst particles supported by the electron conducting oxide in the pores of the mesoporous carbon.

The mesoporous carbon according to the present invention may include pores in other regions (the micropore region, macropores), i.e., pores not in the mesopore region (from 2 nm to 50 nm), but preferably has a large proportion of the pores in the mesopore region.

The structure (pore size, shape, etc.) of the pores of the mesoporous carbon can be observed with an electron microscope. Examples of the electron microscope include a field emission scanning electron microscope (FESEM) and a scanning transmission electron microscope (STEM).

It is preferable that the pores in the mesopore region of the mesoporous carbon include not only isolated pores independent of other pores but also include interconnected pores formed by interconnection between some or all of pores in the mesopore region and an adjacent pore in the mesopore region, and thus have a three-dimensional network structure. The presence of the interconnected pores facilitates diffusion of substances inside the pores of the mesoporous carbon.

The size and shape of the electrode material depend on the size and shape of the mesoporous carbon which is a skeletal material. The size and shape of the mesoporous carbon are determined such that, in a fuel cell electrode formed using the electrode material, the electrode material can continuously contact with each other, and spaces that allow gases such as hydrogen and oxygen in the fuel cell electrode to be smoothly diffused and allow water (steam) to be smoothly discharged can be formed.

The mesoporous carbon used for the electrode material of the present invention may be appropriately synthesized, or a commercially available product. Examples of the commercially available product include CNovel series (designed mesopore size: from 5 to 150 nm) manufactured by Toyo Tanso Co., Ltd., which is mesoporous carbon produced by using MgO as a mold.

The carbon support in the electrode material (C) is a carbon support including, on the surface thereof, the electron conducting oxide layer.

As the carbon support in the electrode material (C) (the third aspect), any carbon support used for a secondary cell, or a fuel cell can be used. The shape and size of the carbon support can be appropriately selected in consideration of the intended use of the electrode, and the like. However, in a gas diffusion electrode application such as a fuel cell electrode, an electrode formed should have high electrical conductivity and high gas diffusibility. Thus, to achieve both high electrical conductivity and high gas diffusivity, it is preferable that the carbon support in particulate form has a particle size of from 0.03 to 500 m, and the carbon support in fibrous form has a diameter of from 2 nm to 20 m and a total length of approximately 0.03 to 500 m.

As the carbon support (for the third aspect), at least one of mesoporous carbon and particulate solid carbon is used. The mesoporous carbon is as described above, and thus description thereof will be omitted. As the solid carbon, carbon black (CB) or graphitized carbon black (GCB) obtained by graphitizing (crystallizing) carbon black can be suitably used. The particulate solid carbon preferably has a secondary particle size of from 0.03 to 500 m (and a primary particle size of from about 10 nm to 100 nm).

The solid carbon may be a self-made product or a commercially available product. Examples thereof include “Vulcan” series (product number: XC-72 or the like) manufactured by Cabot Corporation, “GCB” series (product number: GCB200 or the like) manufactured by Cabot Corporation, and “TOKA BLACK” series (product number: TOKABLACK #3800 or the like) manufactured by Tokai Carbon Co., Ltd.

One type of carbon support may be used, or two or more types of carbon materials different in size (particle size, fiber diameter and fiber length), crystallinity, and/or the like may be used in any proportion.

The electron conducting oxide layer on the surface of the carbon support may be formed of any electron conducting oxide stable under the cathode condition of the PEFC, and examples thereof include an electron conducting oxide containing, as a main component, an oxide of a metal element selected from tin (Sn), molybdenum (Mo), niobium (Nb), tantalum (Ta), titanium (Ti), and tungsten (W). As used herein, “electron conducting oxide containing, as a main component, . . . ” includes (A) an oxide including only a matrix oxide, and (B) an oxide doped with another element and containing the matrix oxide in an amount of 80 mol % or more.

Among them, an electron conducting oxide containing tin oxide as a main component is preferable, and niobium-doped tin oxide doped with from 0.1 to 20 mol % of niobium (Nb) is particularly preferable, because use of such a niobium-doped tin oxide can further enhance electronic conductivity.

The thickness of the electron conducting oxide layer in part depends on the kind and amount of the electron conducting oxide, but is preferably from 1 to 10 nm. The electron conducting oxide layer preferably covers the entire surface of the carbon support, but may partly cover the surface.

### Electrode Catalyst Composite Body

The electrode catalyst composite body according to the present invention includes the electrode catalyst particles and electron conducting oxide, and is characterized in that the electron conducting oxide is present so as to fill gaps between the electrode catalyst particles. This configuration of the electrode catalyst composite body allows the electrode material of the present invention to prevent the electrode catalyst particles from aggregating to form a large mass, and have both of excellent durability against electrochemical oxidation imparted by the electron conducting oxide and excellent electron conductivity imparted by the carbon support.

The form of the electrode catalyst composite body supported on the carbon support may be any form as long as the object of the present invention is not impaired, and examples thereof include a particle form, an island form, and a film form.

From the viewpoint of conductivity in an electrode formed, it is preferable that the electrode catalyst composite bodies are in the form of particles, and dispersively supported such that the surface of the carbon support is partially exposed rather than being entirely covered by the particulate electrode catalyst composite bodies and thus direct contact between the carbon supports is not inhibited.

“The size of the electrode catalyst composite body” can be obtained from an average value of sizes of randomly selected electrode catalyst composite bodies (20 electrode catalyst composite bodies) observable in an electron microscope image. When the shape of an electrode catalyst composite body is not spherical, the length in the direction of the maximum length is used as the size of the electrode catalyst composite body.

The electrode catalyst composite bodies supported on the surface of the carbon support typically have an average particle size of from 10 to 500 nm. The “average particle size of the electrode catalyst composite bodies” can be obtained from an average value of particle sizes of randomly selected electrode catalyst composite bodies (20 electrode catalyst composite bodies) observable in an electron microscope image.

When the carbon support is mesoporous carbon, some or all of the electrode catalyst composite bodies may be present in the pores of the mesoporous carbon. In this case, the size of the electrode catalyst composite body should be smaller than the pore size of the mesoporous carbon, and is from 2 to 30 nm correspondingly to the pore size (for example, from 3 to 40 nm) of the mesoporous carbon.

The proportion of the electrode catalyst composite bodies in the pores of the mesoporous carbon relative to the total number (corresponding to 100%) of electrode catalyst composite bodies (the sum of the number of electrode catalyst composite bodies outside the pores and the number of electrode catalyst composite bodies in the pores) is preferably 50% or more, more preferably 80% or more, and even more preferably 90% or more (including 100%).

The number of electrode catalyst composite bodies in the pores of the mesoporous carbon can be determined using a high-angle annular dark-field scanning transmission electron microscopy (HAADF-STEM).

The loading amount of the electrode catalyst composite bodies is appropriately determined such that a sufficient amount of electrode catalyst particles for serving as an electrode is included. The loading amount of the electrode catalyst composite bodies is determined in consideration of the kind, crystallinity, particle size, and the like of the electrode catalyst metal, as well as the kind, crystallinity, particle size, and the like of the Sn oxide combined with the electrode catalyst metal to form the composite, because these factors affect the activity of the electrode catalyst particles.

The loading amount of the electrode catalyst composite bodies is, for example, typically from 5 to 50 wt. %, and preferably from 10 to 40 wt. % relative to the total weight (corresponding to 100 wt. %) of the carbon support and the electrode catalyst composite bodies.

Hereinafter, the electrode catalyst particles and the electron conducting oxide included in the electrode catalyst composite body will be described in detail.

### Electrode Catalyst Particles

The electrode catalyst particles are particles of an electrode catalyst metal. Any of noble metal catalysts and non-noble metal catalysts which can serve as an electrochemical catalyst for oxygen reduction (and hydrogen oxidation) can be used as the electrode catalyst metal. The electrode catalyst metal is preferably a metal selected from noble metals such as Pt, Ru, Ir, Pd, Rh, Os, Au, and Ag, and noble-metal-containing alloys containing these noble metals. The “noble-metal-containing alloy” includes “an alloy including only the above-listed noble metals” and “an alloy including 10 mass % or more of any of the above-listed noble metal and another metal”. The “other metal” to be alloyed with a noble metal is not particularly limited, but preferred examples thereof include Co, Ni, W, Ta, Nb, and Sn, and one or more of these metals may be used. In addition, two or more of the above-mentioned noble metals and noble-metal-containing alloys, may be used in a phase-separated state.

Among the electrode catalyst metals, Pt and an alloy containing Pt are highly electrochemically catalytically active for oxygen reduction (and hydrogen oxidation) in a temperature range around 80° C., which is the operating temperature of the polymer electrolyte fuel cell, and thus can be particularly suitably used.

The shape of the electrode catalyst particles 3b is not particularly limited as long as the object of the present invention is not impaired, and may be various shapes. Specific examples of the shape include a spherical shape, an elliptical shape, and a polyhedral shape. The structure of the electrode catalyst particles 3b is not limited to a crystal and may be amorphous or a mixture of crystalline and amorphous forms.

A smaller size of the electrode catalyst particles increases the effective surface area on which the electrochemical reaction proceeds, resulting in improvement of electrochemical catalytic activity. However, if the size of the electrode catalyst particles is too small, the electrochemical reaction activity is lowered. Thus, the electrode catalyst particles preferably have an average particle size of from 1 to 10 nm, and more preferably from 1.5 to 5 nm.

The “average particle size of the electrode catalyst particles” in the present invention can be obtained from an average value of particle sizes of electrode catalyst particles (20 particles) observable in an electron microscope image. In calculating the average particle size by using the electron microscope image, if a fine particle has a nonspherical shape, the length in the direction of the maximum length of the particle is used as the particle size.

That is, a preferred example of the electrode catalyst particles in the electrode material of the present invention is particles of a noble metal (preferably Pt and an alloy containing Pt) having an average particle size of from 1 to 10 nm.

The amount of the electrode catalyst particles is determined in consideration of desired electrode catalyst activity and the dopant and the amount of the electron conducting oxide combined with the electrode catalyst particles to form a composite. The loading amount of the electrode catalyst particles can be determined by, for example, inductively coupled plasma emission spectrometry (ICP).

From the viewpoint of electrode catalytic activity, the amount of the electrode catalyst particles is preferably from 0.1 to 60 mass %, and more preferably from 0.5 to 30 mass % relative to the total weight of the electrode material. The amount of the electrode catalyst particles within these ranges can result in excellent catalyst activity per unit mass and desired electrode reaction activity commensurate with the loading amount.

### Electron Conducting Oxide

The electron conducting oxide included in the electrode catalyst composite body has both sufficient durability and electron conductivity under the PEFC cathode condition.

The electron conducting oxide has any shape as long as the object of the present invention is not impaired, and examples thereof include a particulate form, an island form, and a film form, but a particulate form is preferable. In addition, the electron conducting oxide is not limited to be crystalline, and may be amorphous or in a mixture of a crystal form and an amorphous form. However, to further enhance excellent electron conductivity, the electron conducting oxide is preferably crystalline.

Examples of the electron conducting oxide included in the electrode catalyst composite body include an electron conducting oxide containing, as a main component, an oxide of a metal element selected from tin (Sn), molybdenum (Mo), niobium (Nb), tantalum (Ta), titanium (Ti), and tungsten (W).

Among them, an electron conducting oxide containing tin oxide as a main component (Sn oxide) is preferable.

The Sn oxide is an electron conducting oxide containing tin oxide (SnO₂) as a main component. Here, in the present invention, “electron conducting oxide containing tin oxide as a main component” includes (A) an oxide including only tin oxide (SnO₂) which is a matrix oxide, and (B) an electron conducting oxide doped with another element and containing tin oxide (SnO₂) which is the matrix oxide in an amount of 80 mol % or more.

Specific examples of the element to be doped include Ti, Sb, Nb, Ta, W, In, V, Cr, Mn, and Mo (provided that the element is different from the element contained in the matrix oxide). The element to be doped is an element having a valence higher than that of the matrix oxide, and selected from the above-listed dopants excluding Sn (for example, Sb, Nb, Ta, W, In, V, Cr, Mn, or Mo). Among them, niobium (Nb) can significantly enhance the electronic conductivity of tin oxide, and thus niobium-doped tin oxide doped with from 0.1 to 20 mol % of niobium may be used.

As described above, in the electrode catalyst composite body of the present invention, the electron conducting oxide which is present so as to fill the gaps between the electrode catalyst particles inhibits aggregation of the electrode catalyst particles. Thus, the electron conducting oxide may be included in any manner that allows this purpose to be achieved.

The proportion of the electron conducting oxide in the electrode catalyst composite body is appropriately determined depending on the kind, size, and crystallinity of the electron conducting oxide, as well as the kind, amount, and size of the electrode catalyst metal combined with the electron conducting oxide to form the composite. For example, when the electrode catalyst metal is Pt, Pt:Sn=0.1 to 10:1 (molar ratio).

Note that, in the electrode material (B) and the electrode material (C), the electron conducting oxide is used to fill gaps between the electrode catalyst particles in the electrode catalyst composite body and thus, the electron conducting oxide can be small and the electric resistance by the electron conducting oxide can be reduced. Thus, the electron conducting oxide may be crystalline or amorphous. However, to further reduce the electric resistance, it is preferable that the electron conducting oxide is at least in part crystalline, and it is preferable that the entire electron conducting oxide is crystalline.

### Method for Producing Electrode Material (B) or Electrode Material (C)

A method for producing the above-described electrode material (B) and electrode material (C) is not particularly limited, and a suitable method may be appropriately selected depending on the types of the carbon support, the electron conducting oxide, and the electrode catalyst metal to be included in the electrode material. A preferred example method for producing the electrode material (B) or the electrode material (C) of the present invention will be described below.

The method for producing the electrode material (B) of the present invention includes the following steps (1B) to (2B).
Step (1B): Dissolving an acetylacetonate compound being an electrode catalyst metal precursor and an acetylacetonate compound being an electron conducting oxide precursor, in a dispersion prepared by dispersing mesoporous carbon being a carbon support in a hydrophobic organic solvent, stirring the dispersion, and distilling off the solvent to obtain the mesoporous carbon on which the electrode catalyst metal precursor and the electron conducting oxide precursor are supported
Step (2B): Subjecting, a heat treatment in an inert gas atmosphere, the mesoporous carbon obtained in the step (1B) on which the electrode catalyst metal precursor and the electron conducting oxide precursor are supported, to form an electrode catalyst composite body

A specific example of the method for producing the electrode material (B) of the present invention is a method which will be described later in Examples.

The method for producing the electrode material (B) of the present invention is characterized in that, in the step (1B), the hydrophobic organic solvent is used, the acetylacetonate compound of the electrode catalyst metal and the acetylacetonate compound of the electron conducting oxide are used as precursor compounds of the electrode catalyst metal and the electron conducting oxide, respectively, loading the precursor compounds on the carbon support (the mesoporous carbon) is performed in one step, and as a result, an electrode catalyst composite body precursor which is a composite (nanocomposite) of the electrode catalyst metal and the electron conducting oxide can be obtained. In addition, the acetylacetonate compound advantageously does not contain impurities such as chlorine and sulfur, which may degrade the performance of the electrode catalyst.

In the step (2B), the carbon support obtained in the step (1B) on which the electrode catalyst metal precursor and the electron conducting oxide precursor are supported, is subjected to a heat treatment in an inert gas atmosphere, to form an electrode catalyst composite body.

In the heat treatment in an inert atmosphere such as nitrogen gas or argon gas in the step (2B), the electrode catalyst composite body precursor including the electrode catalyst precursor and the electron conducting oxide precursor is decomposed, resulting in activation of the metals being the electrode catalyst as electrochemically active catalyst, enhancement of the crystallinity of the electron conducting oxide, and improvement of the electronic conductivity.

In the production method of the present invention, the heat treatment temperature in the step (2B) is appropriately determined in consideration of the decomposition temperature of the starting acetylacetonate compounds used. The heat treatment is preferably carried out in two stages at different temperatures.

When the electron conducting oxide is a Sn oxide and the electrode catalyst is Pt or a Pt alloy, the heat treatment temperature is typically from 180 to 400° C., and preferably from 200 to 250° C. If the temperature is too low, the activation of the metal serving as the electrode catalyst becomes insufficient, and if the temperature is too high, the electrode catalyst metal aggregate and the effective reaction surface area becomes too small.

In addition, the step (2B) preferably includes a heat treatment step performed in the presence of steam. Performing the heat treatment in the presence of steam (in humidified atmosphere) may improve the electrode performance, because under such a condition, the electron conducting oxide precursor is sufficiently decomposed and oxidized.

The method for producing the electrode material (C) of the present invention includes the following steps (1C) to (3C).
Step (1C): forming an electron conducting oxide layer on a carbon support formed of mesoporous carbon or particulate solid carbon
Step (2C): dissolving an acetylacetonate compound being an electrode catalyst metal precursor and an acetylacetonate compound being an electron conducting oxide precursor, in a dispersion prepared by dispersing, in a hydrophobic organic solvent, the carbon support obtained in the step (1C) on which the electron conducting oxide layer is formed, stirring the dispersion, and distilling off the solvent to obtain the carbon support on which the electron conducting oxide layer is formed and the electrode catalyst metal precursor and the electron conducting oxide precursor are supported
Step (3C): subjecting, to a heat treatment in an inert gas atmosphere, the carbon support obtained in the step (2C) on which the electrode catalyst metal precursor and the electron conducting oxide precursor are supported, to form an electrode catalyst composite body

A specific example method for producing the electrode material (C) of the present invention will be described later in Examples.

The method for producing the electrode material (C) of the present invention is characterized in that, as described in the step (1C), an electron conducting oxide layer is formed in advance on the carbon support on which the electrode catalyst composite body precursor as described in the electrode material (B) (composite formed by the electrode catalyst particles and the electron conducting oxide) is to be loaded (adhered).

The electron conducting oxide forming the electron conducting oxide layer is as described above, the precursor compound thereof is not limited as long as the desired electron conducting oxide layer can be obtained, and examples thereof include chlorides and alkoxide compounds.

In the step (1C), the electron conducting oxide layer is formed on the carbon support formed of mesoporous carbon or particulate solid carbon. A preferable specific example method includes dispersing the carbon support in a solvent (for example, absolute ethanol), adding a precursor compound of the electron conducting oxide layer, and adding aqueous ammonia dropwise while stirring.

Forming the electron conducting oxide layer may include the following steps (1-1C) and (1-2C), in accordance with the steps (1A) and (2A) in the above-described method for producing the electrode material (A).
Step (1-1C): Mixing, in a non-aqueous organic solvent, a carbon support and an alkoxide compound being an electron conducting oxide precursor, to form a uniform mixture, and then distilling off the solvent to dry the mixture
Step (1-2C): Subjecting the dried product obtained in the step (1-1C) to a steam treatment to decompose the electron conducting oxide precursor, and then subjecting the resultant product to a heat treatment to obtain a porous composite support on which an electron conducting oxide layer is formed

The conditions of the steps (1-1C) and (1-2C) are substantially the same as those of the steps (1A) and (2A), and thus description thereof will be omitted.

In addition, the step (2C) (loading the electrode catalyst composite body precursor on the carbon support) and the step (3C) (forming the electrode catalyst composite body), which are steps subsequent to the step (1C), are substantially the same as the steps (1B) and (2B) of the method for producing the electrode material (B) of the present invention, respectively, and thus the description thereof is omitted.

### 2. Electrode

The electrode of the present invention includes the above-described electrode material of the present invention (the electrode materials (A) to (C)) and a proton conducting electrolyte material. In the electrode of the present invention, the electrode material of the present invention is in contact with each other to form a conductive path.

Hereinafter, a fuel cell electrode formed using the electrode material of the present invention will be described. Specifically, a case where the above-described electrode material is used as an electrode in a PEFC will be described. Note that the electrode material of the present invention can also be used as an electrode other than a fuel cell electrode (for example, an electrode for a polymer electrolyte membrane water electrolyzer).

The electrode of the present invention may include only the above-described electrode material, but typically further includes a proton conducting electrolyte material (hereinafter, may be referred to as “proton conducting electrolyte material” or simply “electrolyte material”) used for an electrolyte of a fuel cell. The electrolyte material included in the electrode of the fuel cell together with the electrode material may be the same as or different from the electrolyte material used in the electrolyte membrane for a fuel cell. From the viewpoint of improving adhesion between the fuel cell electrode and the electrolyte membrane, it is preferable to use the same material.

Examples of the electrolyte material used for the electrode and the electrolyte membrane of the PEFC include a proton conducting electrolyte material. The proton conducting electrolyte materials are roughly classified into a fluorocarbon electrolyte material having a polymer skeleton containing in part or entirely fluorine atoms and a hydrocarbon electrolyte material not containing fluorine atoms in a polymer skeleton, and both of them can be used as the electrolyte material.

Specific preferable examples of the fluorocarbon electrolyte material include Nafion (trade name, manufactured by DuPont de Nemours, Inc.), Aciplex (trade name, manufactured by Asahi Kasei Corporation), and FLEMION (trade name, manufactured by AGC Inc.).

Specific preferred examples of the hydrocarbon electrolyte material include polymers such as polysulfonic acid, polystyrene sulfonic acid, polyaryletherketone sulfonic acid, polyphenyl sulfonic acid, polybenzimidazole sulfonic acid, polybenzimidazole phosphonic acid, and polyimide sulfonic acid, and polymers obtained by adding a side chain such as an alkyl group to these polymers.

The mass ratio between the electrode material and the electrolyte material mixed with the electrode material may be appropriately determined such that, in the electrode formed using these materials, excellent proton conductivity is achieved and gas diffusion and steam discharge smoothly occur. If the amount of the electrolyte material mixed with the electrode material is too large, the proton conductivity is improved, but the gas diffusibility is lowered. On the other hand, if the amount of the electrolyte material mixed is too small, the gas diffusibility is improved but the proton conductivity is lowered. Thus, the mass ratio of the electrolyte material to the electrode material is preferably in a range of from 10 to 50 mass %. If the mass ratio is less than 10 mass %, the continuity of the proton conductive material becomes poor, and thus sufficient proton conductivity for a fuel cell electrode cannot be achieved. On the other hand, if the mass ratio is more than 50 mass %, the continuity of the electrode material becomes poor, and the fuel cell electrode may not have sufficient electron conductivity. Furthermore, diffusion of gases (oxygen, hydrogen, and steam) inside the electrode may be hindered.

The fuel cell electrode of the present invention may include another component in addition to the electrode material and the proton conducting material described above, as long as the object of the present invention is not impaired.

For example, the electrode material may include a conductive material other than the carbon support included in the electrode material (hereinafter referred to as “additional conductive material”). Inclusion of the additional conductive material may increase the number of conductive paths connecting the electrode material, and thus improve the conductivity of the electrode as a whole.

As an additional conductive material, a known conductive material used for a fuel cell electrode can be used. The additional conductive material is typically a carbon-based conductive material, and examples thereof include particulate carbon such as carbon black and activated carbon (including chain-connected carbon particles), and fibrous carbon such as carbon fiber and carbon nanotube (CNT). Mesoporous carbon not supporting anything may be used as the additional conductive material.

Although the fuel cell electrode containing the electrode material of the present invention has been described as an electrode for PEFC, the fuel cell electrode can be used as an electrode in various fuel cells other than PEFC, such as an alkaline fuel cell and a phosphoric acid fuel cell. The electrode can also be suitably used as an electrode for a water electrolyzer using a polymer electrolyte membrane similar to that of PEFC.

The fuel cell electrode including the electrode material of the present invention has excellent electrochemical catalytic activity for reduction of oxygen and oxidation of hydrogen, and thus can be used as a cathode and an anode. In particular, the fuel cell electrode including the electrode material of the present invention is excellent in electrochemical catalytic activity for oxygen reduction and resistant to electrochemical oxidative decomposition of the conductive material used as a support under the operating condition of a fuel cell, and thus can be suitably used as a cathode.

Although the fuel cell electrode of the present invention can be used as an electrode in various fuel cells other than PEFC, such as an alkaline fuel cell and a phosphoric acid fuel cell. The electrode can also be suitably used as an electrode for a water electrolyzer using a solid polymer electrolyte membrane similar to that of PEFC.

### 3. Membrane Electrode Assembly (MEA)

A membrane electrode assembly of the present invention is a membrane electrode assembly, including, a solid polymer electrolyte membrane, a cathode bonded to one surface of the solid polymer electrolyte membrane, and an anode bonded to the other surface of the solid polymer electrolyte membrane, which is characterized in that one or both of the anode and the cathode are the electrode of the present invention described above.

As a preferred embodiment of the present invention, a membrane electrode assembly in which a fuel cell electrode including the electrode material of the present invention is used as a cathode will be described.

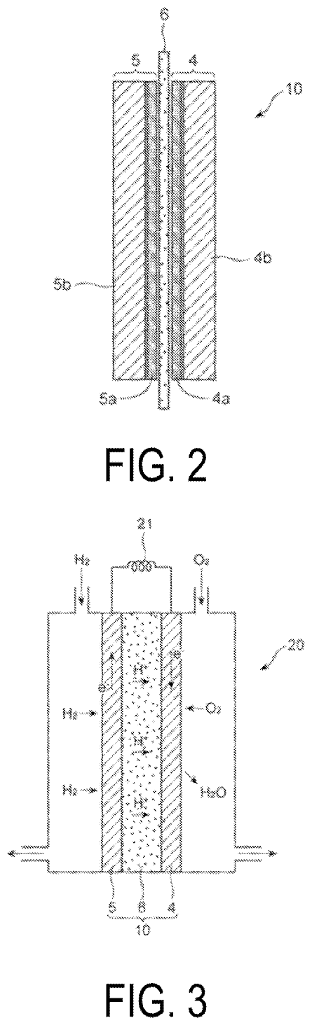

FIG. 2 is a schematic view of a cross-sectional structure of a membrane electrode assembly according to an embodiment of the present invention. As illustrated in FIG. 2, a membrane electrode assembly 10 has a structure in which a cathode 4 and an anode 5 are disposed to face a solid polymer electrolyte membrane 6.

The cathode 4 includes an electrode catalyst layer 4a and a gas diffusion layer 4b.

As the gas diffusion layer 4b, a known conventional gas diffusion layer can be used. For example, an electrically conductive carbon-based sheet-like material having a pore size distribution of about 100 nm to about 90 m, which is conventionally used as a gas diffusion layer of PEFC, may be used, and carbon cloth, carbon paper, carbon nonwoven fabric, or the like subjected to a water repellent treatment may preferably be used. Alternatively, a sheet-like member made of stainless steel or the like may be used instead of carbon-based materials. The thickness of such a gas diffusion layer 4b is not particularly limited, but is typically about 50 m to about 1 mm. The gas diffusion layer 4b may include, on one surface thereof, a microporous layer formed of aggregates of fine carbon particles having an average particle size of about 10 to about 100 nm and a water repellent material.

The anode 5 includes an electrode catalyst layer 5a and a gas diffusion layer 5b. As the anode 5, instead of the fuel cell electrode of the present invention, another known anode can also be used. Examples of such an anode include an electrode including the gas diffusion layer 5b and the electrode catalyst layer 5a formed on the gas diffusion layer 5b, where the electrode catalyst layer 5a is formed by applying and drying a dispersion including an electrode material and a electrolyte material for fuel cells, the electrode material includes an electrically conductive support and catalytic noble metal particles supported on the surface of the electrically conductive support, and the electrically conductive support includes a carbon-based material such as graphite, carbon black, activated carbon, carbon nanotube, glassy carbon, or the like. The gas diffusion layer 5b of the anode 5 may be similar to the gas diffusion layer 4b described for the cathode 4.

As the solid polymer electrolyte membrane 6, any known electrolyte membranes for PEFC which are proton conductive, chemically stable, and thermal stable may be used. Although the thickness of the solid polymer electrolyte membrane 6 is exaggerated in FIG. 3, the thickness of the solid polymer electrolyte membrane 6 is typically about 0.007 to about 0.05 mm to reduce the electrical resistance.

Examples of the electrolyte material forming the solid polymer electrolyte membrane 6 include fluorocarbon electrolyte materials and hydrocarbon electrolyte materials. In particular, an electrolyte membrane formed of a fluorocarbon electrolyte material is excellent in heat resistance, chemical stability, and the like, and thus is preferable. Specific preferable examples thereof include Nafion (trade name, manufactured by DuPont de Nemours, Inc.), Aciplex (trade name, manufactured by Asahi Kasei Corporation), and FLEMION (trade name, manufactured by AGC Inc.).

Although the embodiments of the MEA of the present invention have been described above with reference to the drawings, these are merely examples of the present invention, and other various configurations can be adopted.

### 4. Polymer Electrolyte Fuel Cell

A polymer electrolyte fuel cell (unit cell) of the present invention includes the membrane electrode assembly of the present invention, and typically has a structure in which the membrane electrode assembly is sandwiched between separators in which gas flow paths are formed.

FIG. 3 is a conceptual diagram illustrating a typical configuration of the polymer electrolyte fuel cell of the present invention. As illustrated in FIG. 3, hydrogen is supplied to the anode 5 in a polymer electrolyte fuel cell 20, and protons (H⁺) and electrons are generated as a result of (Reaction 1) 2H₂→4H⁺+4e⁻. The generated protons are supplied to the cathode 4 via the solid polymer electrolyte membrane 6, and the generated electrons are supplied to the cathode via an external circuit 21. At the cathode 4, the protons and the electrons react with oxygen to produce water in accordance with (Reaction 2) O₂+4H⁺+4e⁻→2H₂O.

The electrochemical reactions at the anode and the cathode generate a potential difference between the anode and the cathode. In the polymer electrolyte fuel cell of the present invention, constituent elements other than the membrane electrode assembly of the present invention are the same as those of known polymer electrolyte fuel cells, and thus detailed description thereof will be omitted.

In practical use, a fuel cell stack is formed by stacking a quantity of the polymer electrolyte fuel cells (unit cells) of the present invention determined based on the power generation performance, and is assembled with other accompanying devices such as a gas supply device and a cooling device.

### EXAMPLES

Hereinafter, the present invention will be described more specifically with reference to examples, but the present invention is not limited to these. In the following description, mesoporous carbon may be referred to as “MC”, carbon black may be referred to as “CB”, and graphitized carbon black may be referred to as “GCB”.

### Electrode Material (A)

### A1. Preparation of Electrode Material (A)

As the electrode materials (A) of Examples, the following electrode materials of Examples 1A and 2A were produced.

Carbon supports, electrode catalyst precursors, and electron conducting oxides which were used are as follows.

### Carbon Support

As a carbon support, the mesoporous carbon (MC) (“porous carbon CNovel MJ(4)010 (grade name)” manufactured by Toyo Tanso Co., Ltd.) was used, and the specification thereof is as follows.

Designed pore size: 10 nm

Specific surface area: 1100 m²/g

Total pore volume: 2.0 mL/g

Micro pore volume: 0.4 mL/g

Particle size: 100 mesh pass (used after grinding)

### Electron Conducting Oxide Precursor Compound

Tin ethoxide (Sn(OC₂H₅)₄) (Strem Chemicals, Inc) was as a Sn raw material compound. Niobium ethoxide (Nb(OC₂H₅)₅) (Sigma-Aldrich) was used as a Nb raw material compound.

### Electrode Catalyst Precursor

Pt acetylacetonate (Pt(C₅H₇O₂)₂, Platinum(II) acetylacetonate, 97%, Sigma-Aldrich) was used as an electrode catalyst precursor. Hereinafter, the Pt acetylacetonate may be referred to as a Pt precursor (Pt(acac)₂).

### Example 1A

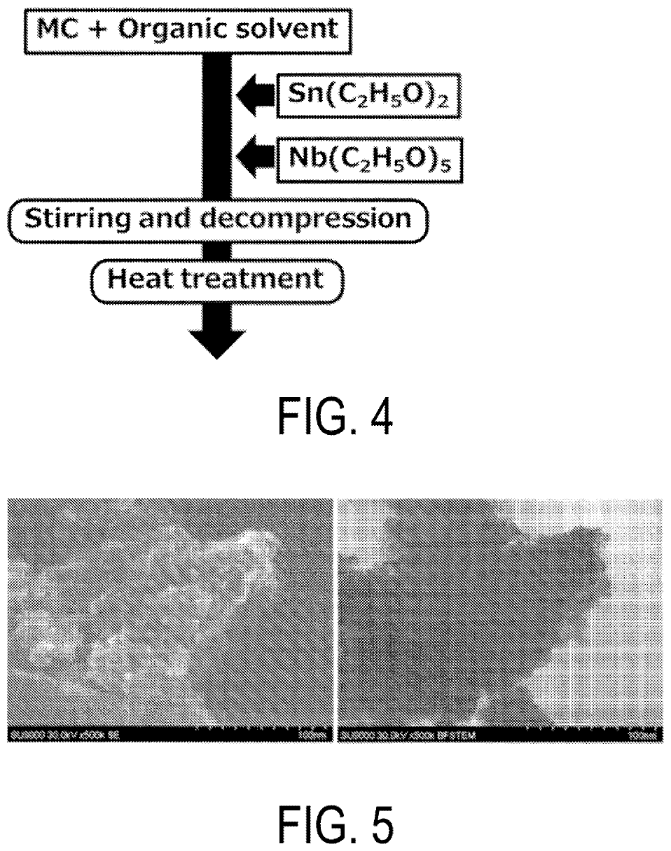

An electrode material of Example (not loaded with electrode catalyst) was prepared by using a steam hydrolysis method, as illustrated in the flowchart of FIG. 4.

First, as the step (1A), 200 mg of the mesoporous carbon (MC) to be used as carbon support was pulverized using a ball mill to produce particles having particle sizes of about 1 m, and then the particles are dispersed in an organic solvent (a mixture of acetylacetone and toluene, the volume ratio: 2:1) to obtain a dispersion containing MC. Next, metal ethoxide reagents (750 mg of tin ethoxide and 128 mg of niobium ethoxide) were dissolved in a mixed organic solvent such that, in the resulting metal ethoxide solution, Sn:Nb=90:10 (molar ratio) was achieved. The metal ethoxide solution is added to the dispersion containing MC, and the total amount of the solvents was adjusted to 45 mL. The mixture was subjected to ultrasonic stirring under a reduced pressure to vaporize the organic solvents. As a result, dry powder including the metal ethoxide reagents uniformly adsorbed on the MC surfaces (the internal surface inside the pores and the external surface outside the pores) was obtained.

The resulting dry powder was pulverized. Then, as step (2A), the powder was treated for 3 hours in a steam atmosphere at 150° C. (3% humidified, N₂ atmosphere) to hydrolyze the metal ethoxide reagents by steam hydrolysis. Then, the temperature was increased to 300° C. and held for 3 hours to crystallize niobium-doped tin oxide (Sn_{0.9}Nb_{0.1}O₂) (confirmed by XRD). Thereafter, the powder was naturally cooled to room temperature to obtain an electrode material (not loaded with electrode catalyst, “Sn_{0.9}Nb_{0.1}O₂/MC”) of Example 1A.

Next, as steps (3A) and (4A), a platinum acetylacetonate method was used to load Pt catalytic particles as electrode catalyst particles onto the electrode material of Example 1A (not loaded with electrode catalyst). The amount of the Pt precursor (Pt(acac)₂) was determined such that 20 wt. % of Pt was included.

In a recovery flask, the electrode material of Example 1A (not loaded with electrode catalyst) being MC loaded with niobium-doped tin oxide and the Pt precursor were placed, and dichloromethane was added to dissolve the Pt precursor. Next, while cooling the recovery flask with ice, the mixture was stirred with an ultrasonic stirrer until the solvents were completely volatilized, to obtain a dry powder (step (3A)).

Next, the obtained dry powder was subjected to a reducing treatment in an N₂ atmosphere at 210° C. for 3 hours and at 240° C. for 3 hours (step (4A)). As a result, an electrode material of Example 1A (Pt/Sn_{0.9}Nb_{0.1}O₂/MC) was obtained.

### Example 2A

An electrode material of Example 2A (loaded with Pt, “Pt/Sn_{0.98}Nb_{0.02}O₂/MC”) was prepared in the same manner as Example 1A, except that the metal ethoxide solution was prepared so as to have Sn:Nb=98:2 (molar ratio) and the dry powder to which the metal ethoxide reagents were adsorbed was heated to 400° C. (Example 1A: 300° C.). Note that crystalline niobium-doped tin oxide (Sn_{0.98}Nb_{0.02}O₂) was formed in the electrode material of Example 2A (confirmed by XRD).

### Comparative Example 1

As a comparative example, an electrode material (Pt/MC) of Comparative Example 1 was prepared in the same manner as in Example 1A except that the metal ethoxide solution was not used.

### A2. Physical Property Evaluation

### A2-1. Fine Structure Observation

(1) Electrode Material (Not Loaded with Electrode Catalyst)

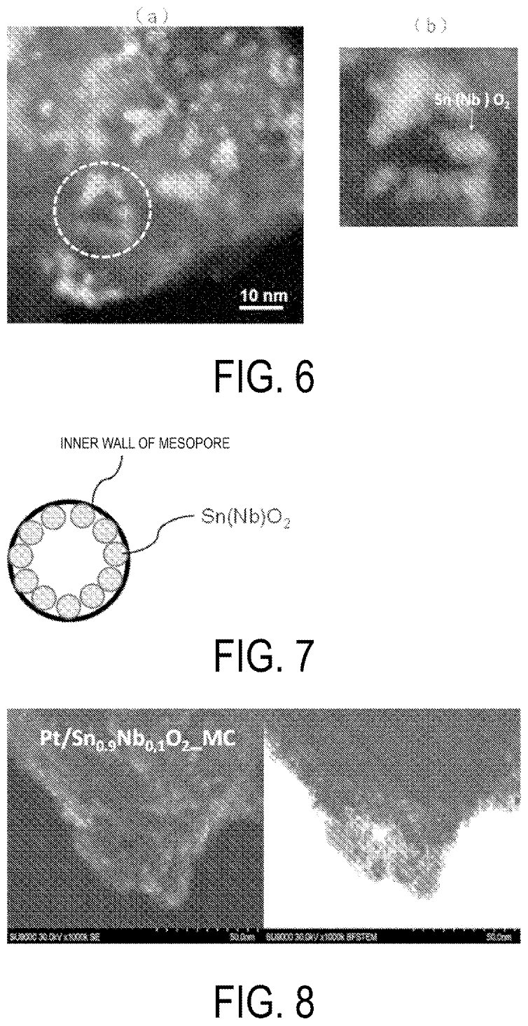

FIG. 5 shows an FESEM image and a STEM image (top view) of the electrode material of Example 1A (not loaded with electrode catalyst). FIG. 6(a) is an FESEM image (top view) of the electrode material of Example 2A (not loaded with electrode catalyst), and FIG. 6(b) is an enlarged image of a region indicated by a dashed line in FIG. 6(a) (corresponding to a mesopore).

As can be seen in FIGS. 5 and 6(a), it was observed that particulate Sn(Nb)O₂ having sizes of 2 to 5 nm was adhered to the external surface of MC in the electrode material of Example 1A and the electrode material of Example 2A.

In addition, from observation of the inside of a mesopore using an enlarged image of the region indicated by the dashed line in FIG. 6(a), it was revealed that Sn(Nb)O₂ having a particle size of about 2 nm (particle size of 3 nm or less) covered the internal surface of the mesopore. FIG. 7 is an image of particulate Sn(Nb)O₂ inside a pore (mesopore) of MC.

(2) Electrode Material (Loaded with Pt)

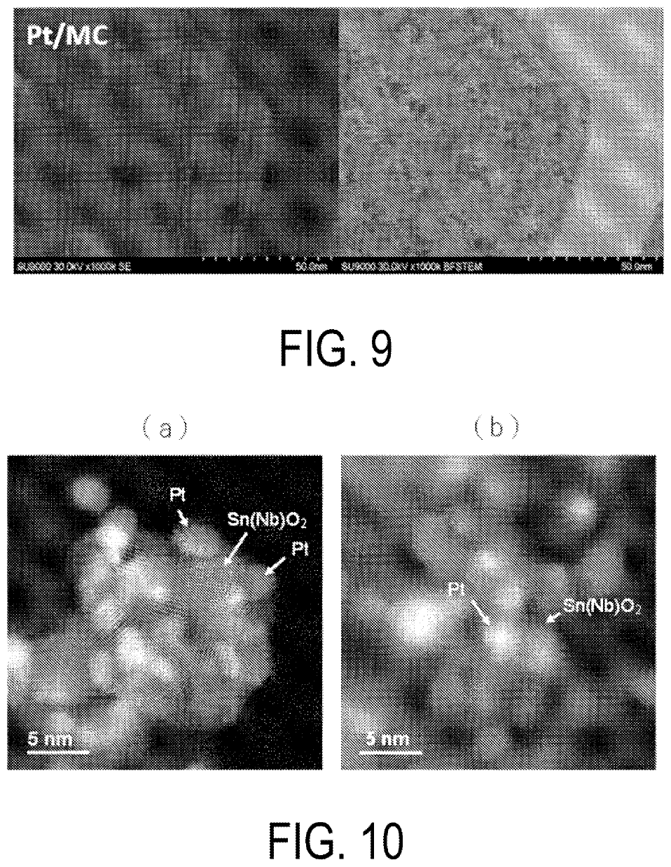

FIG. 8 shows an FESEM image and a STEM image (top view) of the electrode material of Example 1A (Pt/Sn_{0.9}Nb_{0.1}O₂/MC), and FIG. 9 shows an FESEM image and a STEM image (top view) of the electrode material of Comparative Example 1 (Pt/MC). From FIG. 8, it was confirmed that the electrode material of Example 1A included Pt fine particles dispersively supported on MC via Sn(Nb)O₂. From FIG. 9, it was confirmed that, in the electrode material of Comparative Example 1, Pt fine particles were directly supported on the MC.

FIGS. 10(a) and 10(b) are STEM images (top views) of the electrode material of Example 2A (Pt/Sn_{0.98}Nb_{0.02}O₂/MC).

It was confirmed that, on the external surface of the electrode material of Example 2A, as shown in FIG. 10(a), Pt fine particles (having particle sizes of from 2 to 3 nm) were supported on particulate Sn(Nb)O₂. In addition, as shown in FIG. 10(b), it was confirmed that, in a mesopore (having a diameter of about 10 nm) of the electrode material of Example 2A, Pt fine particles were supported on Sn(Nb)O₂ existed.

### A3. Electrochemical Evaluation (Half Cell)

### A3-1. Evaluation Using Cyclic Voltammetry (CV)

The electrode materials of Example 1A and Comparative Example 1 were evaluated using cyclic voltammetry (CV). An electrochemical surface area (ECSA) was calculated from a hydrogen adsorption amount obtained using the CV. Note that ECSA corresponds to the effective surface area of Pt contained in the electrode material.

A fuel cell electrode used in the evaluation was produced by using the following procedure.

First, a mixed solution of 19 mL of ultrapure water and 6 mL of 2-propanol was added to electrode material powder in a sample bottle, then 100 μL of a 5% Nafion dispersion was added thereto. Then, the mixture was subjected to ultrasonic stirring for 30 minutes in a state where the sample bottle was immersed in ice water, to obtain an electrode material dispersion. The amount of the electrode material powder was such that the mass of Pt per unit area on the electrode is 17.3 μg_{-Pt}·cm⁻² when 10 μL of the dispersion of the electrode material is dropped on the electrode. Using a micropipette, 10 μL of the prepared electrode material dispersion was dropped onto the Au disk electrode and dried in a constant temperature oven at 60° C. for about 15 minutes. As a result, a Nafion film was formed and the electrode material was fixed on the Au electrode, which was used as a fuel cell electrode (working electrode) for evaluation.

Measurement conditions of CV are as follows. Note that, assuming that one H atom is adsorbed per one Pt atom, the quantity of electricity is 210 μC/cm².

Measurement: three electrode cell (working electrode: fuel cell electrode for evaluation, counter electrode: Pt, reference electrode: Ag/AgCl)

Electrolyte: 0.1 M HClO₄ (pH: about 1)

Measurement potential range: 0.05 to 1.2 V (vs. reversible hydrogen electrode)

Scan rate: 50 mV/s

Hydrogen adsorption amount: calculated from a peak area indicative of hydrogen adsorption at 0.05 to 0.4 V

Electrochemical surface area (ECSA): calculated from the following equation.

ECSA=(hydrogen adsorption amount) [μC]/210 [μC/cm²]

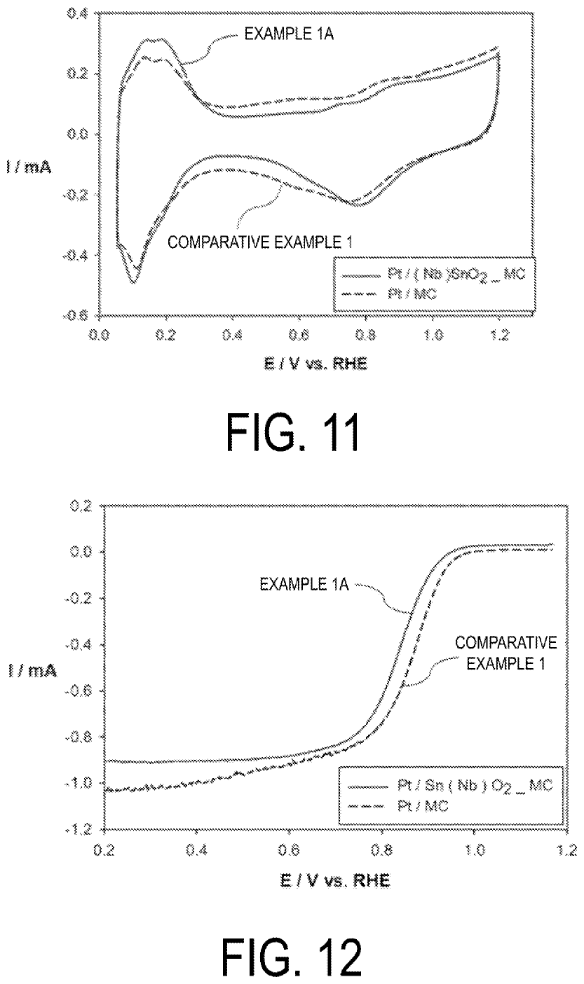

FIG. 11 shows the CVs of the electrode materials of Example 1A and Comparative Example 1. As can be seen in FIG. 11, for the electrode using the electrode material of Example 1A (Pt/Sn_{0.9}Nb_{0.1}O₂/MC), peaks (0.05 to 0.4 V) due to hydrogen adsorption and desorption were observed, and thus it was confirmed that the electrode can function as a fuel cell electrode.

It was also confirmed that the electrode material of Example 1A (Pt/Sn_{0.9}Nb_{0.1}O₂/MC) had a larger hydrogen adsorption amount and a larger electrochemical surface area (ECSA), than the electrode material of Comparative Example 1 (Pt/MC) which does not include electron conducting oxide (ECSA, Example 1A: 112 m²/g, Comparative Example 1: 79.5 m²/g).

### A3-2. Evaluation of ORR Activity

The electrode materials of Example 1A and Comparative Example 1 were evaluated in terms of ORR activity.

As a measure of ORR activity, mass activity (activity per unit Pt mass) was used. The mass activity is calculated based on a kinetic current (iₖ) obtained by performing linear sweep voltammetry (LSV) using a rotating disk electrode method (RDE method).

Mass activity=iₖ/Pt mass on electrode

For a current-potential curve obtained from rotating electrode measurement, a Koutecky-Levich plot was created by plotting i⁻¹ versus ω^{-1/2} at an arbitrary potential. By extrapolating the obtained line, an intercept was obtained, and the kinetic current (iₖ) was determined from the intercept.

In a specific procedure, first, O₂ bubbling was performed at 50 mL/min for 30 minutes, and then measurement was performed while sweeping the potential in the positive direction from 0.2 V_{RHE} to 1.20 V_{RHE} at a rate of 10 mV/s. During the measurement, O₂ was always purged at 50 mL/min. V_{RHE} is a potential versus the reversible hydrogen electrode (RHE).

FIG. 12 shows linear sweep voltammograms (1600 rpm) of the electrode materials of Example 1A and Comparative Example 1. The mass activity at 0.9 V_{R}HE of the electrode material of Example 1A obtained by the ORR measurement in FIG. 12 was 38.2 A/g__{Pt}.

### A3-3. Start-Stop Cycle Test

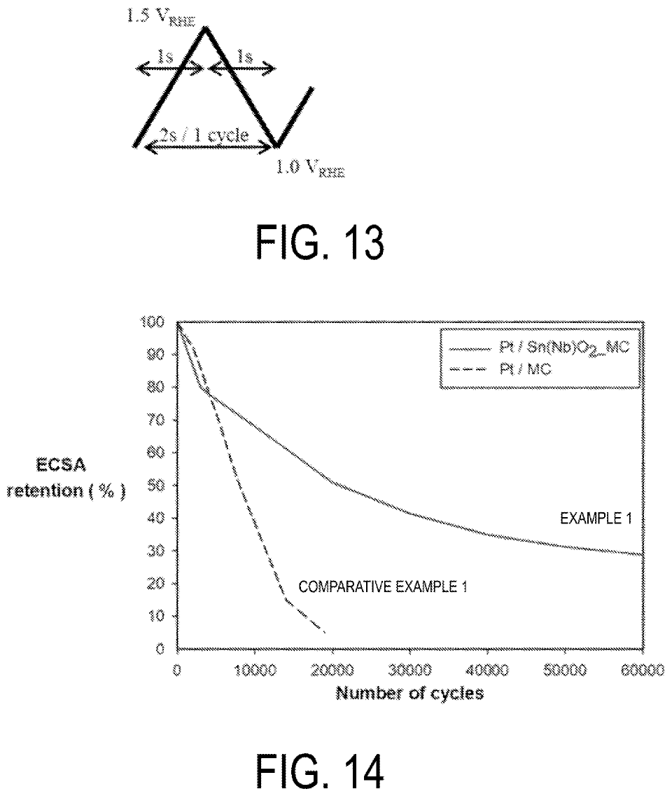

A start-stop cycle test was performed on the electrode materials of Example 1A and Comparative Example 1 according to a method recommended by Fuel Cell Commercialization Conference of Japan (FCCJ) (Proposals of the development targets, research and development challenges and evaluation methods concerning PEFCs, issued in January 2011). The start-stop cycle test is a cycle test for accelerating carbon corrosion. Specifically, a square wave shown in FIG. 13 (1.0 to 1.5 V_{RHE}, 2 seconds per cycle) is repeatedly applied, and performance of the deteriorated electrode catalyst after the cycle test was evaluated as an ECSA change.

FIG. 14 shows changes in ECSA (relative values) of the electrode materials of Example 1A and Comparative Example 1 during the start-stop cycle test (up to 60,000 cycles).

As can be seen from FIG. 14, ECSA of the electrode using the electrode material of Comparative Example 1 (Pt/MC), significantly decreased immediately after the start-stop cycle test, and decreased to about 50% of the initial value at 10,000 cycles. The test for the electrode using the electrode material of Comparative Example 1 was discontinued before the number of cycles reaches 20,000 (the ECSA retention was decreased to substantially 0). On the other hand, it was demonstrated that ECSA decrease of the electrode using the electrode material of Example 1A (Pt/Sn_{0.9}Nb_{0.1}O₂/MC) was more moderate and about 30% of the initial value could be retained even at 60,000 cycles.

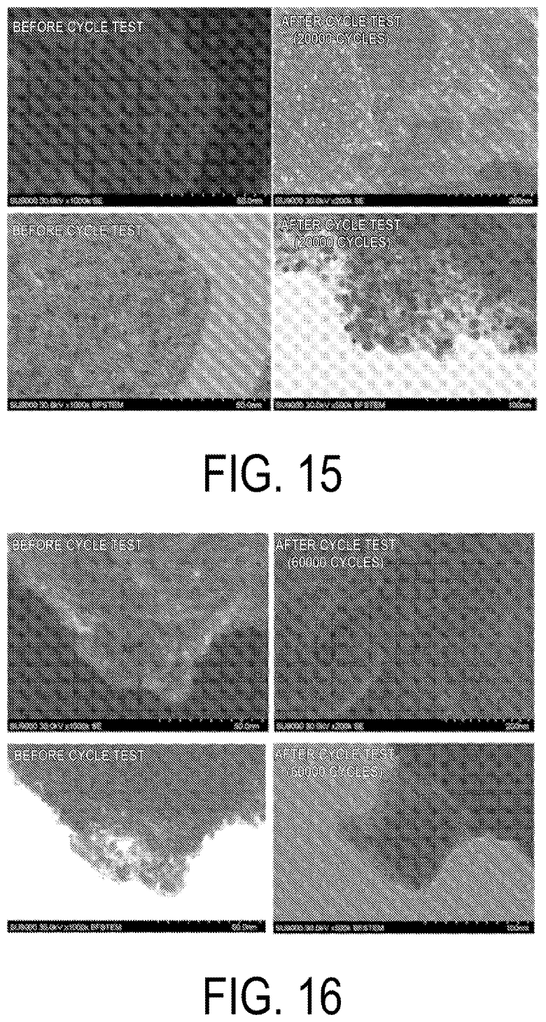

FIG. 15 shows FESEM images and STEM images of the electrode material of Comparative Example 1 (Pt/MC) before and after the start-stop cycle test (20,000 cycles), and FIG. 16 shows FESEM images and STEM images of the electrode material of Example 1A (Pt/Sn_{0.9}Nb_{0.1}O₂/MC) before and after the start-stop cycle test (60,000 cycles).

From the these results, it was revealed that the electrode material of Example 1A retained a state in which the Pt particles are highly dispersively supported on the MC surfaces (the internal surface inside the pores and the external surface outside the pores) via the electron conducting oxide (Sn(Nb)O₂) even after the cycle test, whereas the Pt particles in the electrode material of Comparative Example 1 (Pt/MC) which did not include electron conducting oxide were detached and aggregated as the cycle test progressed.

### Electrode Material (B) and Electrode Material (C)

As the electrode material (B) of Example, an electrode material of Experimental Example 1B, as described below, was prepared. As the electrode material (C) of Example, electrode materials of Experimental Examples 1C and 2C were prepared.

The carbon support, the electrode catalyst precursor, and the electron conducting oxide precursor which were used are as follows.

### Carbon Support

### (1) Carbon Support 1

As the carbon support 1, the mesoporous carbon (MC) (“porous carbon CNovel MJ(4)010 (grade name)” manufactured by Toyo Tanso Co., Ltd.) was used.

Designed pore size: 10 nm

Specific surface area: 1100 m²/g

Total pore volume: 2.0 mL/g

Micro pore volume: 0.4 mL/g

Particle size: 100 mesh pass (used after grinding)

### (2) Carbon Support 2

As the carbon support 2, carbon black (CB) (“Vulcan XC-72” manufactured by Cabot Corporation) was used.

### (3) Carbon Support 3

As the carbon support 3, graphitized carbon black (GCB) (“GCB200” manufactured by Cabot Corporation”) was used.

### Electrode Catalyst Precursor

As the electrode catalyst precursor, Pt acetylacetonate (Platinum(II) acetylacetonate, Sigma-Aldrich) (hereinafter may be referred to as “Pt(acac)₂”) was used.

### Electron Conducting Oxide Precursor

### (1) Sn Oxide Precursor (for Forming Electrode Catalyst Composite Bodies)

As the Sn oxide precursor, Sn acetylacetonate (Tin (II) acetylacetonate, Sigma-Aldrich) (hereinafter may be referred to as “Sn(acac)₂”) was used.

### (2) Precursor for Forming Electron Conducting Oxide Layer

As a Sn raw material compound, tin chloride hydrate (SnCl₂·2H₂O, Kishida Chemical Co., Ltd.) was used. As a Nb raw material compound, niobium chloride (NbCl₅, FUJIFILM Wako Pure Chemical Corporation) was used.

### Experimental Example B

### B1. Preparation of Electrode Material B (Second Aspect)

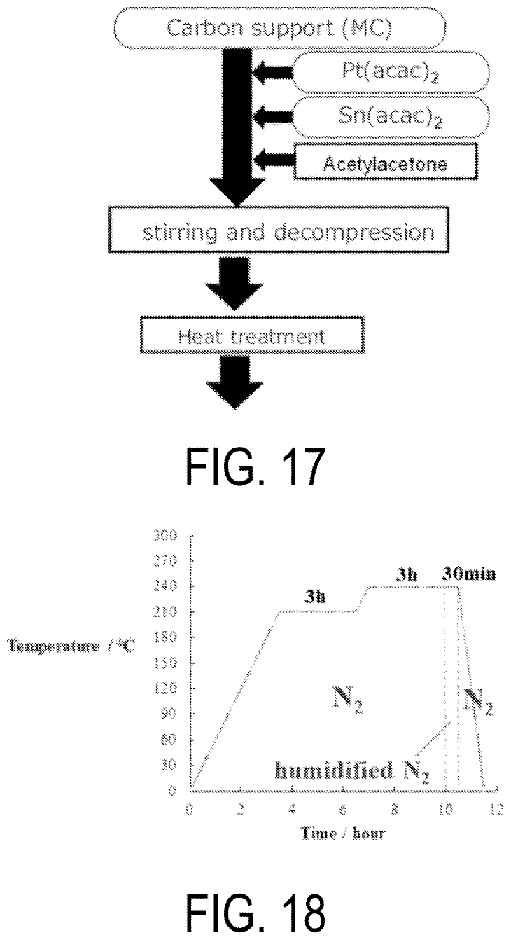

According to the flowchart illustrated in FIG. 17, an electrode material of Experimental Example 1B was produced.

### Experimental Example 1B: Pt—SnO₂/MC

### Step (1B)

First, as the step (1B), 100 mg of the mesoporous carbon (MC) as the carbon support 1 was pulverized using a ball mill to produce particles having particle sizes of about 1 μm and placed into a recovery flask. Then, acetyl acetone (30 mL) was added to the recovery flask, and the mixture was stirred by an ultrasonic homogenizer to obtain a dispersion of MC.

Pt(acac)₂ and Sn(acac)₂ were added to the obtained MC dispersion and the dispersion was sufficiently stirred to dissolve Pt(acac)₂ and Sn(acac)₂.

The charge amounts of the Pt precursor (Pt(acac)₂) and the Sn oxide precursor (Sn(acac)₂) were such that the loading amount of the Pt—SnO₂ electrode catalyst composite bodies relative to the total weight of the electrode material was 42 wt. %. For the charge amount, Pt:SnO₂ (volume ratio)=1:2.

Then, the recovery flask containing the sample was set in a rotary evaporator having a depressurizing function and a rotation function, and ultrasonic stirring was performed while reducing the pressure until all the solvent was volatilized. As a result, a powder (MC on which an electrode catalyst composite body precursor including the Pt precursor and the Sn oxide precursor was supported) was obtained.

### Step (2B)

The powder obtained in the step (1B) was subjected to heat treatment under heat treatment conditions shown in FIG. 18 (in an N₂ atmosphere, at a heating rate of 1° C./min, held at 210° C. for 3 hours, held at 240° C. for 3 hours, and held in a 3% humidified N₂ atmosphere for 30 minutes (treatment for activating the electrode catalyst composite bodies)) to obtain an electrode material of Experimental Example 1B (Pt—SnO₂/MC).

### Experimental Example 2B (Reference Example): Pt—SnO₂/CB (Vulcan)

An electrode material of Experimental Example 2B (Pt—SnO₂/CB (Vulcan)) was prepared in the same manner as in Experimental Example 1B, except that in the step (1), the carbon support 2 (CB (Vulcan)) was used instead of the carbon support 1 (MC) and the loading amount of the Pt—SnO₂ electrode catalyst composite bodies relative to the total weight of electrode material was 32 wt. %. The electrode material of Experimental Example 2B is described here as a reference (Reference Example) to the electrode material of Experimental Example 1B.

Table 1 shows actual loading and volumetric ratios of Pt and SnO₂ calculated based on ICP measurement and TG measurement for the electrode materials of Experimental Example 1B and Experimental Example 2B (Reference Example).

TABLE 1

| | | Actual Pt | Actual SnO₂ | Pt:SnO₂ |
|---|---|---|---|---|
| | Sample name | loading | loading | volume ratio |
| Experimental Example 1B | Pt-SnO₂/MC | 25.7 wt. | 14.6 wt. % | 1:1.75 |
| Experimental Example 2B | Pt-SnO₂/CB(Vulcan) | 18.2 wt. % | 10.5 wt. % | 1:1.78 |

### B2. Physical Property Evaluation

### B2-1. Analysis by X-ray Diffraction (XRD)

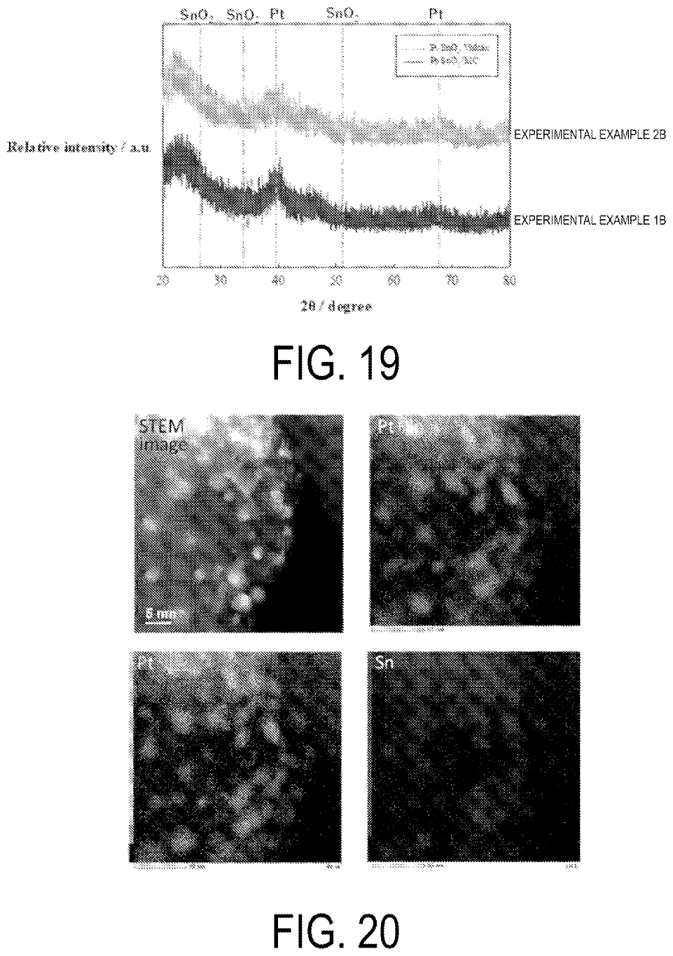

The crystal structure of each prepared electrode material was evaluated by using XRD. FIG. 19 shows XRD patterns of the electrode materials of Experimental Example 1B and Experimental Example 2B. The peak when 20 is about 27° is attributed to the carbon support (MC, CB).

For both of the electrode materials, a peak of Pt was confirmed, and it was confirmed that Pt was present as a crystal. There were no clear peak of the PtSn alloy and no peak shift of Pt. Thus, it was determined that PtSn alloy was not formed and the Sn oxide precursor was sufficiently oxidized to form SnO₂ by the heat treatment in the humidified nitrogen atmosphere.

On the other hand, since no peak of SnO₂ was present for both of the electrode materials, it was determined that Sn was present as very fine SnO₂ crystals or amorphous Sn oxide (SnOx).

### B2-2. Fine Structure Evaluation

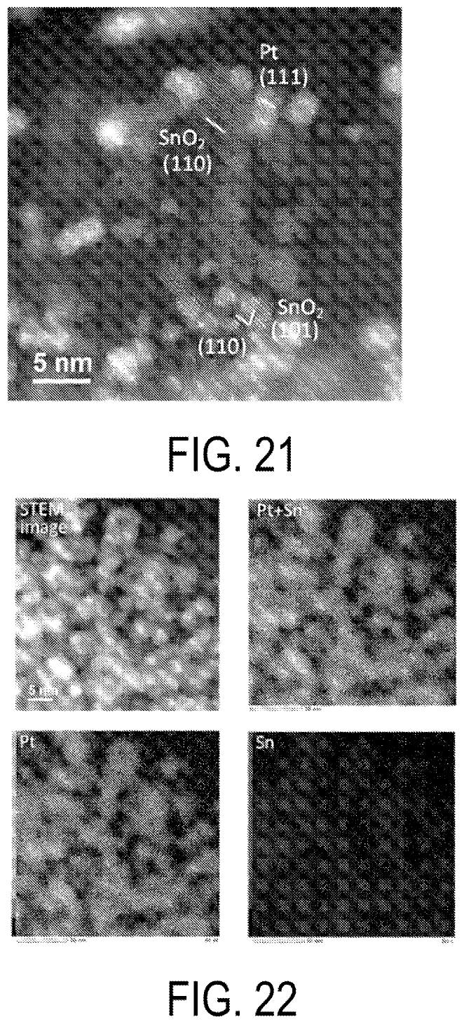

FIG. 20 shows a STEM image and EDS mapping of the electrode material of Experimental Example 2B (Pt—SnO₂/CB (Vulcan)), and FIG. 21 shows a HAADF-STEM image of the electrode material of Experimental Example 2B.

It was confirmed from the STEM image (upper left in FIG. 20) and the HAADF-STEM image (FIG. 21) of the electrode material of Experimental Example 2B that the Pt—SnO₂ electrode catalyst composite bodies were supported on the surface of the carbon support (CB (Vulcan)).

In addition, as can be seen from the EDS analysis of FIG. 20 and FIG. 21, the Pt—SnO₂ electrode catalyst composite body has a composite structure formed by Pt and Sn oxide, in which the Sn oxide is distributed so as to fill the gaps between the Pt particles having a particle size of 1 to 2 nm. It was determined that the Sn oxide existing between Pt particles and filling the gaps between Pt particles suppressed grain growth of Pt and thus fine Pt particles having a particle size of about 1 to 2 nm could be preserved.

As described above, the result of the XRD measurement (FIG. 19) indicated that an alloy of Pt and Sn was not formed, and thus it was determined that, in the electrode material of Experimental Example 2B, the electrode catalyst composite body particles having a nanocomposite structure formed by Pt and SnO₂ were adhered to the carbon support (CB (Vulcan)).

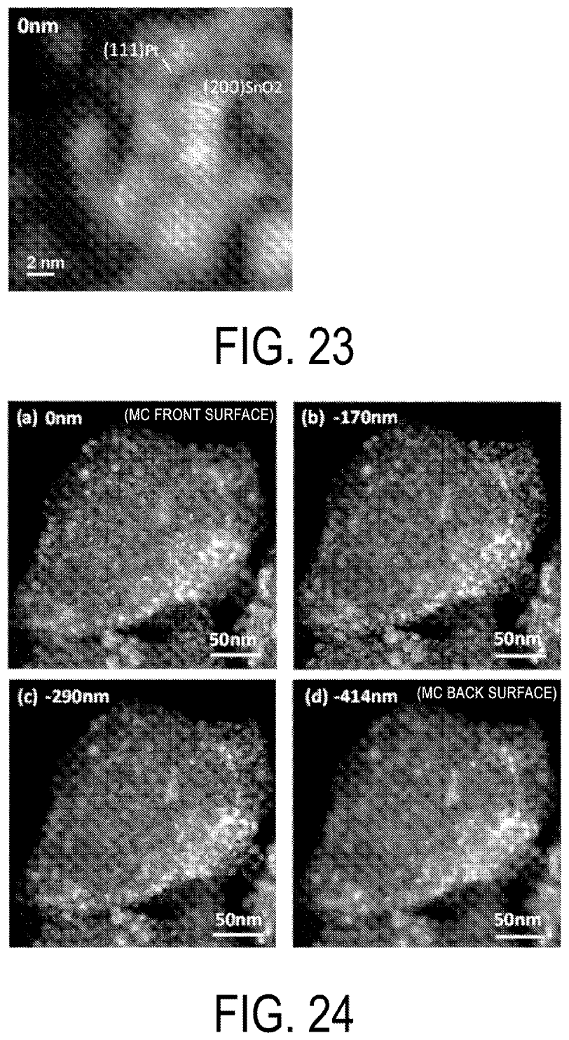

FIG. 22 shows a STEM image and EDS mapping of the electrode material of the Experimental Example 1B (Pt—SnO₂/MC), and FIG. 23 shows a HAADF-STEM image of the electrode material of the Experimental Example 1B.

From the STEM image (upper left in FIG. 22) and the HAADF-STEM image (FIG. 23) of the electrode material of Experimental Example 1B, it was confirmed that particles having a particle size of 1 to 2 nm were highly dispersively supported on the surface of the carbon support (MC).

In addition, as can be seen from the EDS analysis of FIG. 22 and FIG. 23, a composite structure was formed by Pt and Sn oxide, in which the Sn oxide is distributed so as to fill the gaps between the Pt particles having a particle size of 1 to 2 nm. It was determined that the Sn oxide existing between Pt particles and filling the gaps between Pt particles suppressed grain growth of Pt and thus fine Pt particles having a particle size of about 1 to 2 nm could be preserved.

As described above, the result of the XRD measurement (FIG. 19) indicated that an alloy of Pt and Sn was not formed, and thus it was determined that, in the electrode material of Experimental Example 1B, the electrode catalyst composite body particles having a nanocomposite structure formed by Pt and SnO₂ were adhered to the carbon support (MC).

Further observation by using STEM to confirm whether the Pt—SnO₂ electrode catalyst composite bodies were successfully supported in the mesopores of the MC was performed, and the results is shown in FIG. 24. In FIGS. 24(a) to 24(d), focal lengths when the focal length for the MC surface is defined as 0 nm are indicated in parentheses.

As shown in FIG. 24, existence of the Pt—SnO₂ electrode catalyst composite body particles were confirmed not only on a front surface (FIG. 24(a)) and a back surface (FIG. 24(d)) of the MC, but also inside the MC (FIGS. 24(b) and 24(c)). That is, it was determined that the Pt—SnO₂ electrode catalyst composite bodies were also supported inside the MC.

The number of particles inside the MC and the number of particles outside the MC in FIGS. 24(a) to 24(d) were counted and the proportion of the particles inside the MC was calculated. The proportion was 55.3%, which means that more than half of the particles were supported in the mesopores.

### B3. Electrochemical Evaluation (Half Cell)

### B3-1. Evaluation Using Cyclic Voltammetry (CV)

The electrode materials of Experimental Example 1B and Experimental Example 2B were evaluated using cyclic voltammetry (CV). An electrochemical surface area (ECSA) was calculated from a hydrogen adsorption amount obtained using the CV. Note that ECSA corresponds to the effective surface area of Pt contained in the electrode material.

The details of the evaluation method are the same as those described in “A3-1. Evaluation Using Cyclic Voltammetry (CV)”, and thus description thereof is omitted here.

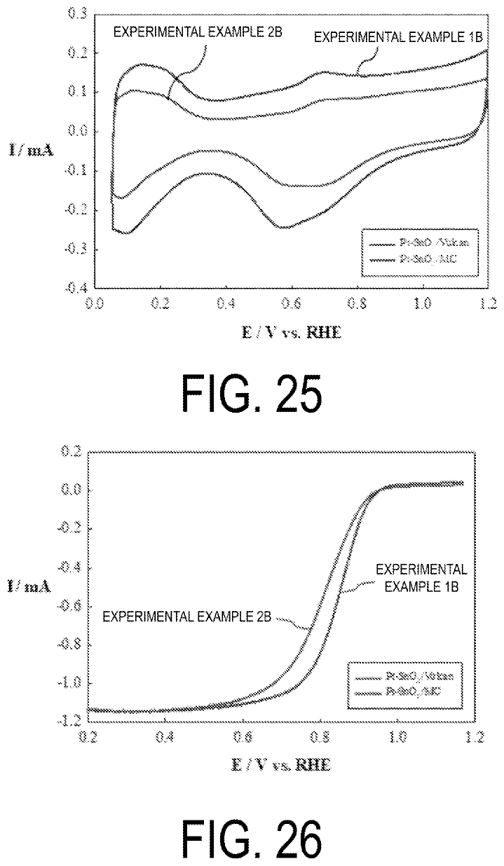

FIG. 25 shows CVs of the electrode materials of Experimental Example 1B and Experimental Example 2B. As can be seen in FIG. 25, for the electrodes using the electrode materials of Experimental Example 1B and Experimental Example 2B, peaks (0.05 to 0.4 V) due to hydrogen adsorption and desorption were observed, and thus it was confirmed that the electrodes can function as a fuel cell electrode.

Further, it was found that the electrode material of Experimental Example 1B using MC as the carbon support had a larger hydrogen adsorption amount and a larger electrochemically effective surface area (ECSA) than the electrode material of Experimental Example 2B using CB (Vulcan) as the carbon support (ECSA: Experimental Example 1B: 48.0 m²/g, Experimental Example 2B: 39.1 m²/g).

### B3-2. Evaluation of Oxygen Reduction Reaction Activity (ORR Activity)

The electrode materials of Experimental Example 1B and Experimental Example 2B were evaluated in terms of ORR activity.

The details of the evaluation method are the same as those described in “A3-2. Evaluation of Oxygen Reduction Reaction Activity (ORR Activity)”, and thus description thereof is omitted here.

FIG. 26 shows linear sweep voltammograms (1600 rpm) of the electrode materials of Experimental Example 1B and Experimental Example 2B. Mass activities at 0.9 V_{RHE} of the electrode materials of Experimental Example 1B and Experimental Example 2B obtained in the ORR measurement in FIG. 26 were 62.3 A/g_{Pt} for Experimental Example 1B and 44.9 A/g__{Pt} for Experimental Example 2B.

The mass activity of Experimental Example 1B (Pt—SnO₂/MC) being slightly larger than that of Experimental Example 2B (Pt—SnO₂/CB (Vulcan)) implies that the use of mesoporous carbon as the carbon support contributed to improvement of the activity of the Pt—SnO₂ electrode catalyst composite bodies.

### B3-3. Start-Stop Cycle Test

A start-stop cycle test was performed on the electrode material of Experimental Example 1B.

The details of the evaluation method are the same as those described in “A3-3. Start-stop cycle test”, and thus description thereof is omitted here.

For comparison, the start-stop cycle test was also performed on the electrode material of Comparative Example 1 (Pt/MC), which does not include Sn oxide, by using the same method as that for the electrode material of Experimental Example 1B.

The ECSA retention (relative to the initial value) after the start-stop cycle test (60,000 cycles) was about 0 for the electrode material (Pt/MC) of Comparative Example 1, whereas it was 11.6% for the electrode material of Experimental Example 1B (Pt—SnO₂/MC).

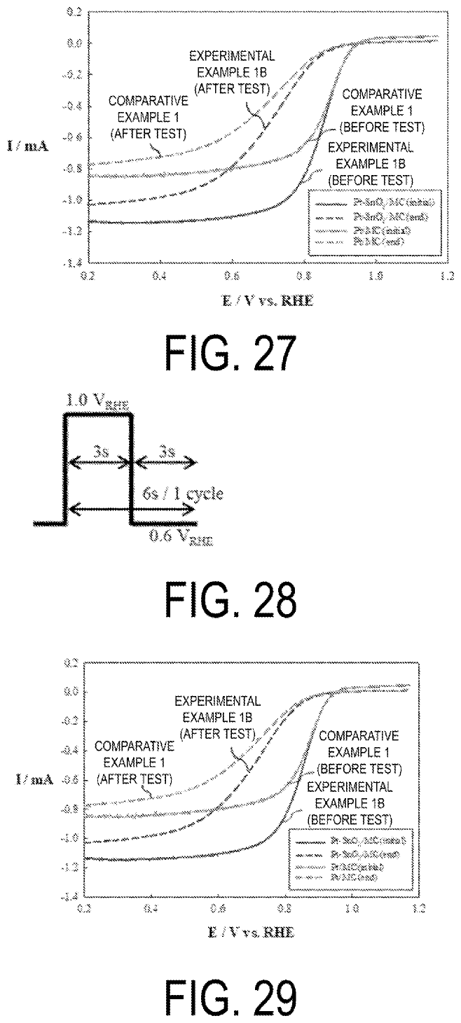

FIG. 27 shows linear sweep voltammograms (1600 rpm) of the electrode materials of Experimental Example 1B and Comparative Example 1 before and after the start-stop cycle test (60,000 cycles).

As can be seen from the LSV curves of FIG. 27, negative shift between the oxygen reduction potentials before and after the test for the electrode material of Experimental Example 1B was slightly suppressed as compared that of the electrode material of Comparative Example 1. Thus, it was found that the electrode material of Experimental Example 1B (Pt—SnO₂/MC) is more durable than the electrode material of Comparative Example 1 (Pt/MC).

### B3-4. Load Fluctuation Cycle Test

A load fluctuation cycle durability test was performed on the electrode materials of Experimental Example 1B and Comparative Example 1. The load fluctuation cycle test was performed by applying a potential cycle simulating load fluctuation according to a method recommended by Fuel Cell Commercialization Conference of Japan (FCCJ) (Proposals of the development targets, research and development challenges and evaluation methods concerning PEFCs, issued in January 2011). A load fluctuation cycle illustrated in FIG. 28 is a cycle for accelerating deterioration involving dissolution and reprecipitation of the catalyst, an experiment was conducted by applying a square wave (0.6 to 1.0 V_{RHE}, 6 seconds (3+3 seconds) per cycle), and the ECSA change and the LSV change before and after the load fluctuation cycle test were measured.

Although the number of cycles recommended by FCCJ is 400,000 cycles, the test was terminated at 100,000 cycles because the change in the ECSA was remarkable.

The ECSA retention after the load fluctuation cycle test (100,000 cycles) was 22.1% for the electrode material of Comparative Example 1 (Pt/MC) and 26.8% for the electrode material of Experimental Example 1B (Pt—SnO₂/MC).

FIG. 29 shows LSV changes for the electrode materials of Experimental Example 1B and Comparative Example 1 before and after the load fluctuation cycle test (100,000 cycles). From the LSV curves of FIG. 29, it can be seen that the electrode material of Experimental Example 1B (Pt—SnO₂/MC) showed a negative shift of the oxygen reduction potential smaller than that of the electrode material of Comparative Example 1 (Pt/MC), and improvement of durability was confirmed in terms of activity.

### Experimental Example C

### C1. Preparation of Electrode Material (C) (Third Aspect)

As described below, the electrode materials (not loaded with electrode catalyst) of Experimental Example 1C and Experimental Example 2C were produced.

### Experimental Example 1C: Pt—SnO₂/Sn(Nb)O₂/GCB

### Step (1C)

First, 580 mL of anhydrous ethanol was added to GCB as the carbon support 3, and the mixture was stirred with an ultrasonic homogenizer to obtain a dispersion of GCB. To the obtained GCB dispersion, tin chloride hydrate (SnCl₂·2H₂O, Kishida Chemical Co., Ltd.) and niobium chloride (NbCl₅, FUJIFILM Wako Pure Chemical Corporation) were added, and 120 mL of aqueous ammonia was added dropwise at a rate of 5 cc/min with a burette while stirring at 50° C. with a hot stirrer. After dropwise addition was completed, the mixture was stirred for 1 hour. Then, the mixture was filtered and washed four times in total, and then dried at 100° C. for 10 hours. Thereafter, heat treatment was performed at 600° C. for 2 hours in a reducing furnace equipped with a rotating mechanism to obtain a powder of Experimental Example 1C (not loaded with electrode catalyst, “Sn(Nb)O₂/GCB”) which was the carbon support on which a Sn oxide layer is formed. In the step (1C), the preparation was performed such that the Sn(Nb)O₂ loading was 75 wt. % (charge amount).

### Step (2C)

By using a ball mill, 100 mg of the carbon support (Sn(Nb)O₂/GCB) obtained in the step (1C) on which Sn oxide layer is formed was pulverized to produce particles having particle sizes of about 1 μm and placed into a recovery flask. Then, acetylacetone (30 mL) was added to the recovery flask, and the mixture was stirred by an ultrasonic homogenizer to obtain a dispersion of the carbon support (with the Sn oxide layer).

Pt(acac)₂ and Sn(acac)₂ were added to the obtained dispersion of the carbon support (with the Sn oxide layer) and the dispersion was sufficiently stirred to dissolve Pt(acac)₂ and Sn(acac)₂.

The charge amounts of the Pt precursor (Pt(acac)₂) and the Sn oxide precursor (Sn(acac)₂) were such that the loading amount of the Pt—SnO₂ electrode catalyst composite bodies relative to the total weight of the electrode material was 22 wt. %. For the charge amount, Pt:SnO₂ (volume ratio)=1:2.

Then, the recovery flask containing the sample was set in a rotary evaporator having a depressurizing function and a rotation function, and ultrasonic stirring was performed while reducing the pressure until all the solvent was volatilized. As a result, a powder (the carbon support (with the Sn oxide layer) on which an electrode catalyst composite body precursor including the Pt precursor and the Sn oxide precursor was supported) was obtained.

### Step (3C)

The powder obtained in the step (2C) was subjected to heat treatment under heat treatment conditions (in an N₂ atmosphere, at a heating rate of 1° C./min, held at 210° C. for 3 hours, held at 240° C. for 3 hours, and held in a 3% humidified N₂ atmosphere for 30 minutes (treatment for activating the electrode catalyst composite bodies)) to obtain an electrode material of Experimental Example 1C (Pt—SnO₂/Sn(Nb)O₂/GCB).

### Experimental Example 2C: Pt—SnO₂/Sn(Nb)O₂/CB (Vulcan)

An electrode material of Experimental Example 2C (Pt—SnO₂/Sn(Nb)O₂/CB (Vulcan)) was prepared in the same manner as in Experimental Example 1C except that, in the method for producing the electrode material of Experimental Example 1C, the CB (Vulcan) as the carbon support 3 was used instead of GCB as the carbon support 3, and the heat treatment temperature was changed to 300° C.

Table 2 shows actual loading and volumetric ratios of Pt and SnO₂ calculated based on ICP measurement and TG measurement for the electrode materials of Experimental Example 1C and Experimental Example 2C.

TABLE 2

| | | Actual Pt | Actual SnO₂ | Pt:SnO₂ |
|---|---|---|---|---|
| | Sample name | loading | loading | volumetric ratio |
| Experimental | Pt- | 4.21 wt. % | 2.69 wt. % | 1:1.97 |
| Example 1C | SnO₂/Sn(Nb)O₂/GCB | | | |
| Experimental | Pt-SnO₂/Sn(Nb)O₂/CB | 3.54 wt. % | 2.46 wt. % | 1:2.15 |
| Example 2C | (Vulcan) | | | |

### C2. Physical Property Evaluation

### C2-1. Analysis by X-ray Diffraction (XRD)

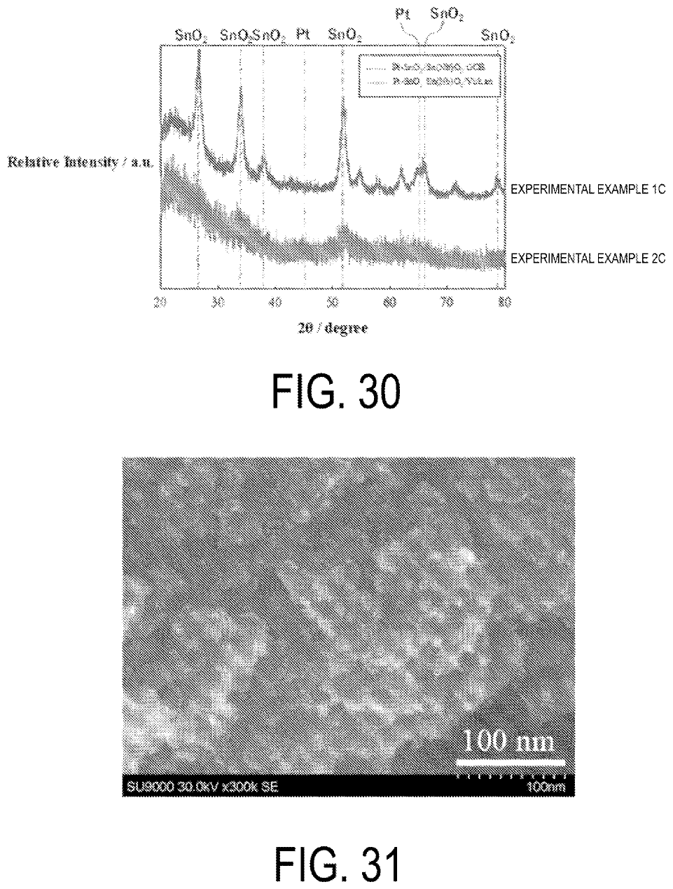

The crystal structure of each prepared electrode material was evaluated by using XRD. FIG. 30 shows XRD patterns of the electrode materials of Experimental Examples 1C and 2C. The peak when 2θ is about 27° is attributed to the carbon support (GCB, CB).

Table 3 shows the crystallite diameters of Sn(Nb)O₂ in the electrode materials of Experimental Example 1C and Experimental Example 2C determined by the Scherrer method.

TABLE 3

| | | Average crystallite diameter of Sn(Nb)O₂ |
|---|---|---|
| | Sample name | particles |
| Experimental | Pt-SnO₂/Sn(Nb)O₂/GCB | 9.42 nm |
| Example 1C | | |
| Experimental | Pt-SnO₂/Sn(Nb)O₂/CB | 5.02 nm |
| Example 2C | (Vulcan) | |

Clear peaks of SnO₂ could be confirmed for both of the electrode materials of Experimental Example 1C and Experimental Example 2C. The electrode material of Experimental Example 2C using CB (Vulcan) showed a peak of SnO₂ smaller than that for the electrode material of Experimental Example 1C using GCB, and had a smaller average crystallite diameter as shown in Table 3. Thus, it can be said that the heat treatment at 300° C. resulted in supporting Sn(Nb)O₂ particles having smaller particle sizes.

### C2-2. Fine Structure Evaluation

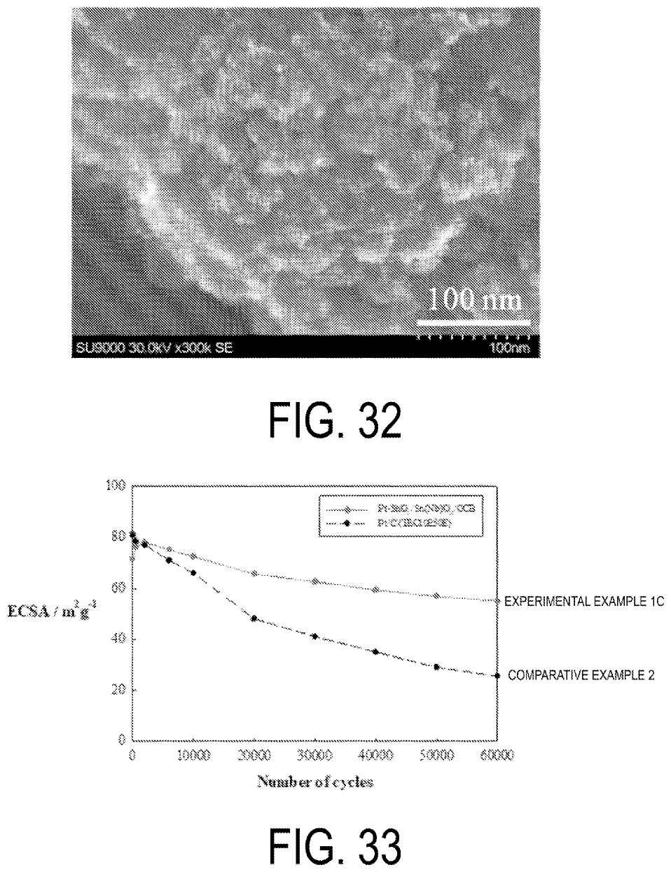

FIG. 31 shows an FESEM image of the electrode material of Experimental Example 1C, and FIG. 32 shows an FESEM image of the electrode material of Experimental Example 2C. In both catalysts, it was confirmed that Pt particles were supported in a highly dispersed state. High-resolution observation was performed by using STEM-EDS and HAADF-STEM on the electrode material of Experimental Example 1C using GCB (figures not provided). In this high-resolution observation, the respective lattice spacings of Pt and SnO₂ were confirmed, and thus it was determined that an alloy of Pt and Sn was not formed.

### C3. Electrochemical Evaluation (Half Cell)

### C3-1. Start-stop Cycle Test

A start-stop cycle test was performed on the electrode material of Experimental Example 1C. The evaluation method is as described above in “A3-3. Start-stop Cycle Test”, and thus the description thereof will be omitted.

FIG. 33 shows changes in mass activity before and after the cycle test. For comparison, as Comparative Example 2, a result for a commercially available platinum-loaded carbon black catalyst (Pt/C, manufactured by Tanaka Kikinzoku Kogyo, TEC10E50E) is also shown. As shown in FIG. 33, it was confirmed that the electrode material of Experimental Example 1C having the Sn(Nb)O₂ support surface layer was more excellent in the start-stop cycle durability than the electrode material of Comparative Example 2.

1. An electrode material being
an electrode material (A) comprising:
a porous composite support including,
a carbon support formed of mesoporous carbon, the mesoporous carbon having an internal surface inside pores and an external surface outside the pores, and
an electron conducting oxide adhered to at least the internal surface inside the pores of the mesoporous carbon; and
electrode catalyst particles supported on the porous composite support, wherein
some or all of the electrode catalyst particles are supported via the electron conducting oxide in the pores of the mesoporous carbon
or
an electrode material (B) comprising:
a carbon support formed of mesoporous carbon, the mesoporous carbon having an internal surface inside pores and an external surface outside the pores; and
an electrode catalyst composite body adhered to at least the internal surface inside the pores of the mesoporous carbon, wherein
the electrode catalyst composite body includes electrode catalyst particles and an electron conducting oxide, and
the electron conducting oxide fills gaps between the electrode catalyst particles.

2. The electrode material according to claim 1, wherein the mesoporous carbon of the electrode material (A) or the electrode material (B) has interconnected pores formed by interconnection between some or all of pores in a mesopore region and an adjacent pore in the mesopore region.

3. The electrode material according to claim 1, wherein a pore size of the mesoporous carbon of the electrode material (A) or the electrode material (B) is 3 nm or more and 40 nm or less.

4. The electrode material according to claim 1, wherein the electron conducting oxide of the electrode material (A) or the electrode material (B) is an electron conducting oxide containing tin oxide as a main component.

5. The electrode material according to claim 4, wherein the electron conducting oxide of the electrode material (A) or the electrode material (B) includes a niobium-doped tin oxide.

6. The electrode material according to claim 1, wherein in the mesoporous carbon of the electrode material (A), a particle size of the electron conducting oxide adhered to the internal surface inside the pores is 0.5 nm or more and 3 nm or less.

7. The electrode material according to claim 1, wherein the electrode catalyst particles included in the electrode catalyst composite body of the electrode material (B) have a particle size of 1 nm or more and 10 nm or less.

8. The electrode material according to claim 7, wherein the electron conducting oxide included in the electrode catalyst composite body of the electrode material (B) is partly or completely crystalline.

9. The electrode material according to claim 1, wherein the electrode catalyst particles are particles of Pt or an alloy containing Pt.

10. An electrode, comprising:
the electrode material according to claim 1; and
a proton conducting electrolyte material.

11. A membrane electrode assembly, comprising:
a solid polymer electrolyte membrane;
a cathode bonded to one surface of the solid polymer electrolyte membrane; and
an anode bonded to the other surface of the solid polymer electrolyte membrane, wherein
one or both of the anode and the cathode are the electrode according to claim 10.

12. A polymer electrolyte fuel cell, comprising the membrane electrode assembly according to claim 11.
